(19) United States
(12) Patent Application Publication
(10) Pub. No.: US 2025/0306938 A1
(43) Pub. Date: Oct. 2, 2025

(54) INSTRUCTION OPERAND PREFIXING COMBINATOR AND DECODER FOR EXTENSIBILITY AND BACKWARD COMPATIBILITY

(71) Applicant: SITARAM YADAVALLI, SAN JOSE, CA (US)

(72) Inventor: SITARAM YADAVALLI, SAN JOSE, CA (US)

(21) Appl. No.: 18/662,639

(22) Filed: May 13, 2024

Related U.S. Application Data
(63) Continuation-in-part of application No. 18/433,384, filed on Mar. 28, 2024.

(51) Int. Cl. G06F 9/30

(52) U.S. Cl. CPC G06F 9/30181; G06F 9/30185; G06F 9/30196

(57) ABSTRACT

Operand augmenting instruction combinators, decoders, and techniques for augmenting instruction operands to existing instructions to create new combined versions of the instructions that are executed. Hardware, computer program products and methods use mechanisms and/or techniques that comprise replacements, substitutions, embeddings, modifications, and/or combinations to include additional source, destination or other operands into instructions by combining them into the existing instructions. Variations in techniques facilitate combining existing instructions with multi-operand prefixes including a condition prefix to convert the existing instructions into conditional execution instructions. instructions can also be augmented with a function, and/or a type and/or a hint to modify the instructions' functionality to handle a wider class of operand types or classes of data, that improve execution speeds, as well as improving instruction set extensibility while maintaining backward compatibility. Instruction extension capability facilitates rapid repurposing of highly used matrix and machine learning related instructions for deep learning models and algorithms.

### CROSS-REFERENCE TO RELATED APPLICATIONS

The present application is a Continuation-in-Part of U.S. Non-Provisional patent application Ser. No. 18/433,384 titled “INSTRUCTION OPERAND PREFIXING COMBINATOR AND DECODER FOR EXTENSIBILITY AND BACKWARD COMPATIBILITY” filed on Feb. 5, 2024, which claims benefit of priority to U.S. Provisional Application No. US 63/444,318 titled “INSTRUCTION OPERAND PREFIXING COMBINATOR AND DECODER FOR EXTENSIBILITY AND BACKWARD COMPATIBILITY” filed on Feb. 9, 2023, both of which applications are incorporated herein by reference.

### FIELD OF THE INVENTION

The present invention generally relates to instruction decoding, and more particularly to decoding instructions in combination with a prefix.

### BACKGROUND OF THE INVENTION

Traditional computing systems comprise instruction decoders that decode instructions in a program sequence. One issue is that in a short length instruction, it may not be possible to include all fields needed for the intended operation of the instruction in such a short length. There is thus a need for overcoming these and/or other issues associated with the prior art.

### SUMMARY OF THE INVENTION

A system comprising instruction operand prefixing combinators and decoders and various associated methods are provided for augmenting instruction operands using prefixing mechanisms to existing instructions to create new combined versions of the instructions that are executed. Hardware, computer program products and methods use the mechanisms and/or perform such combinations to include additional source or destination operands into instructions by way of combining them into the instructions. This allows easy instruction set extensibility while maintaining backward compatibility.

One embodiment comprises a computing machine, comprising at least one processor in communication with a non-transitory memory, wherein the at least one processor executes instructions of the computing machine, the instructions of the computing machine comprising a first instruction and a second instruction, wherein the first instruction is an operand prefix instruction comprising a prefix operand; and further comprising an operand prefix identifying mechanism that identifies the operand prefix instruction and determines the prefix operand; and an operand selection mechanism that selects the prefix operand and combines the prefix operand with at least some portion of the second instruction to create a combined instruction.

In one aspect of the embodiment, the operand prefix identifying mechanism is a prefix instruction identifying pre-decoder. In some aspects, the operand prefix identifying mechanism is implemented in hardware. In some aspects, the operand prefix identifying and/or analyzing mechanism is implemented in microcode, at least in part.

In one aspect, wherein the second instruction comprises a second operand, and wherein the second operand is a source operand and a destination operand, and wherein the prefix operand of the operand prefix instruction serves as the destination operand in the combined instruction. In one aspect, the prefix operand serves as a destination operand of the combined instruction. In some aspect, the prefix operand serves as a source operand of the combined instruction. In one aspect, where in the prefix operand is a register operand.

In some aspects, the second instruction comprises a second operand, and wherein the second operand is a source operand and a destination operand, and wherein the prefix operand of the operand prefix instruction serves as the source operand of the combined instruction.

In one aspect, the operand prefix instruction is transformed into a NOP instruction prior to execution. In some aspect, the operand prefix instruction is suppressed and not executed after creation of the combined instruction. In one aspect, wherein the combined instruction is decoded in an instruction decoder. In some aspects, two instructions comprising the operand prefix instruction and the consuming instruction are, in a single cycle, combined and decoded.

A computing machine comprising an instruction buffer, a pre-decoder, an operand selector and an operand combining logic block, wherein the pre-decoder identifies an operand prefix instruction and asserts an operand selection control signal coupled to the operand selector to select one of a first operand or a second operand to include with a consuming instruction in the operand combining logic block to create a combined instruction.

In one aspect, in response to the selection of the first operand, the combined instruction gains an additional operand over the consuming instruction. In one aspect, wherein the consuming instruction is a two operand instruction, and the combined instruction is a three operand instruction. In some aspects, two instructions comprising the operand prefix instruction and the consuming instruction are, in a single cycle, combined and decoded.

In one aspect, the consuming instruction takes a word length register as a source operand and as a destination operand, and wherein the consuming instruction is modified in response to a first instruction, and wherein the combined instruction generates an extended word length result to write into an extended word length register given by the first operand. In some aspects, the first operand is of a fixed point type and the second operand is of a floating point type.

A computing machine comprising a pre-decoder that identifies an operand prefix instruction and a consuming instruction; an operand analyzer that performs analysis and accepts or rejects a prefix operand for conjunction with the consuming instruction; and an operand combining logic block that combines the prefix operand with the consuming instruction to create a combined instruction for execution. In one aspect, wherein the operand prefix instruction is a condition operand prefix instruction. In one aspect, the operand prefix instruction is a hint operand prefix instruction.

Many of the herein-disclosed embodiments for operand prefixing are technological solutions pertaining to technological problems that arise in the hardware and software arts that underlie computer processor design. Aspects of the present disclosure achieve performance and other improvements in peripheral technical fields including, but not limited to, central processing units.

Some embodiments include a sequence of instructions that are stored on a non-transitory computer readable medium. Such a sequence of instructions, when stored in memory and executed by one or more processors, causes the one or more processors to perform a set of acts for instruction prefixing to extend instruction functionality.

Some embodiments include the aforementioned sequence of instructions that are stored in a memory, which memory is interfaced to one or more processors such that the one or more processors can execute the sequence of instructions to cause the one or more processors to implement acts such as decoding prefix instructions with operands and decoding and executing instructions created by combining the prefix operands with consuming instructions.

In one other embodiment, a computing machine comprising an instruction buffer, a pre-decoder, an operand selector and an operand combining logic block, wherein the pre-decoder identifies an operand prefix instruction and asserts an operand selection control signal coupled to the operand selector to select one of a first operand or a second operand to include with a consuming instruction in the operand combining logic block to create a combined instruction. In one aspect, in response to the selection of the first operand, the combined instruction gains an additional operand over the consuming instruction. In one aspect, the consuming instruction is a two operand instruction, and the combined instruction is a three operand instruction. In some aspects, the consuming instruction takes a word length register as a source operand and as a destination operand, and wherein the consuming instruction is modified in response to a first instruction, and wherein the combined instruction generates an extended word length result to write into an extended word length register given by the first operand. In some embodiments of the computing machine the first operand is of a fixed point type and the second operand is of a floating point type. In many aspects of the computing machine two instructions comprising the operand prefix instruction and the consuming instruction are, in a single cycle, combined and decoded.

In some embodiments, a computing machine comprising a pre-decoder that identifies an operand prefix instruction and a consuming instruction; an operand analyzer that performs analysis and rejects or accepts at least one prefix operand to combine with the consuming instruction; and an operand combiner that combines the at least one prefix operand with the consuming instruction to create a combined instruction for execution. In some aspects, the operand prefix instruction comprises a new destination operand. In some aspects the operand prefix instruction is a condition operand prefix instruction. In some aspects the operand prefix instruction is a hint operand prefix instruction. In some aspects the operand prefix instruction is a type operand prefix instruction. In some aspects the operand prefix instruction is a function operand prefix instruction.

In some embodiments a computing machine may comprise an operand prefixing instruction combinator and decoder that further comprises a first pre-decoder, wherein the first pre-decoder identifies an operand prefix instruction; a second pre-decoder, wherein the second pre-decoder identifies a consuming instruction; at least one operand analyzer that performs analysis and rejects or accepts at least one prefix operand to combine with the consuming instruction; and at least one operand combiner that combines the at least one prefix operand with the consuming instruction to create a combined instruction.

In a further embodiment of the computing machine, the operand prefixing instruction combinator and decoder is a multi-operand prefixing instruction combinator and decoders. In one aspect an operand prefix instruction comprises a condition operand and a destination operand.

In some embodiments, in the computing machine, the operand prefixing instruction combinator and decoder is implemented as a logic circuit, while in some other embodiments the operand prefixing instruction combinator and decoder is implemented in microcode, at least in part.

In some embodiments, such as for example, a binary translation program product or an artificial intelligence model running on a computing machine with at least one processor in communication with a non-transitory memory, wherein the at least one processor executes instructions of the computing machine, wherein the operand prefixing instruction combinator and/or decoder may be implemented in a software program product at least in part. In some embodiments a combined instruction output by the operand prefixing instruction combinator may be decoded by a decoder circuit or further processed in hardware, or it may be translated and/or decoded or further processed in software or in microcode, for execution. In some aspects, a binary translation program product may also be implemented in microcode. Binary translation program products are used to convert binary programs of one instruction set architecture into binary programs of another instruction set architecture, or simply another architecture, even if it is a variant, either in real-time or prior to use.

In various embodiments, any combinations of any of the above can be organized to perform any variation of acts for legacy instruction extensions, and many such combinations of aspects of the above elements are contemplated.

In yet other embodiments, the operand prefixing instruction combinator and decoder may even be used in quantum computers, wherein the actions of pre-decoding, analyzing and combining the pre-fixing instruction(s) and the consuming instruction(s) may be performed using electronic circuits, quantum circuits or any combination of electronic/electrical and quantum mechanical device and process suitable for performing the said actions. For this, any of the foregoing methods, techniques and mechanisms disclosed herein may be used, and in addition other optoelectronics or qubit processing quantum mechanisms/circuits may be used. Such quantum computing mechanisms/devices/circuits or optoelectronics mechanisms/devices/circuits may not use Boolean logic based circuits in some part but may still implement the operand prefixing instruction combinator and decoder in whole or in part to combine instructions for execution.

### BRIEF DESCRIPTION OF DRAWINGS

FIG. 1 illustrates a method for instruction operand prefixing, in accordance with one possible embodiment.

FIG. 2 illustrates an instruction operand prefixing combinator and decoder in a computing system, in accordance with one possible embodiment.

FIG. 3A and FIG. 3B illustrate a comparison of processing flows of two adjacent instructions through an instruction operand prefixing combinator and decoder, in accordance with one possible embodiment.

FIGS. 4A and 4B illustrate examples of instruction flows for processing two adjacent instructions through operand prefixing combinators in a multi-operand instruction scenario, in accordance with one possible embodiment.

FIG. 5 illustrates a computing system comprising one or more instruction operand prefixing combinators and decoders, in accordance with one possible embodiment.

FIG. 6A illustrates an instruction execution path to execute a combined instruction comprising a prefixed operand that includes handling of mixed mode arithmetic, in accordance with one possible embodiment.

FIG. 6B covers several example cases illustrating a representative set of combined instructions that include some for mixed mode arithmetic, in accordance with some embodiments.

FIG. 6C1 and FIG. 6C2 illustrate example timing diagrams contrasting instruction execution in the disclosed mechanism and instruction execution in a legacy implementation, respectively, in accordance with one possible embodiment.

FIG. 7 illustrates a network architecture, in accordance with one possible embodiment.

FIG. 8 illustrates an exemplary system, in accordance with one embodiment.

FIG. 9 illustrates an instruction condition operand prefixing combinator and decoder in a computing system, in accordance with one possible embodiment.

FIG. 10 illustrates an instruction type operand prefixing combinator and decoder in a computing system, in accordance with one possible embodiment.

FIG. 11 illustrates an instruction function operand prefixing combinator and decoder in a computing system, in accordance with one possible embodiment.

FIG. 12 illustrates an instruction hint operand prefixing combinator and decoder in a computing system, in accordance with one possible embodiment.

FIG. 13A illustrates a combined instruction formed by combining two or more instructions in an instruction operand prefixing combinator and decoder, in accordance with one possible embodiment.

FIG. 13B illustrates an instruction operand prefixing combinator and decoder implemented in microcode and hardware, in accordance with one possible embodiment.

FIG. 14A illustrates an instruction combination of operand prefixing instructions and a consuming instruction yielding a combined instruction, in accordance with one possible embodiment.

FIG. 14B illustrates an instruction combination that results in a combined instruction formed by combining a double operand prefix instruction with a consuming instruction, in accordance with one possible embodiment.

FIG. 14C illustrates an instruction combination that results in a combined instruction formed by combining a multi-operand prefix instruction with a consuming instruction and performed by a multi-operand prefixing instruction combinator and decoder, in accordance with one possible embodiment.

FIG. 15A illustrates a multi-operand prefixing instruction combinator and decoder, in accordance with one embodiment.

FIG. 15B illustrates one aspect of a multi-operand prefixing instruction combinator and decoder, in accordance with one embodiment.

FIG. 15C illustrates one further aspect of a multi-operand prefixing instruction combinator and decoder, in accordance with one embodiment.

### DETAILED DESCRIPTION OF THE INVENTION

Traditional computing systems comprise instruction decoders that decode instructions in a program sequence. One issue is that in a short length instruction, it may not be possible to include all fields needed for the intended operation of the short length instruction within such a short length. A prefix instruction is used in the current disclosure to remedy the said issue. A prefix is a field or opcode that may be positioned adjacent to an instruction to change its behavior. For example, in prior art, a ‘rep’ prefix associated with a string comparison instruction allows a comparison of two strings till an end of string is found or till the comparison results in an inequality.

While prefixes like ‘rep’ have been used before, prefix instructions with operands have not been used to augment any additional operands to existing program instruction(s) to modify the structure and/or behavior of the program instruction(s), as claimed. As used herein, a prefix instruction with a prefix operand at least requires partial decode of a field of a subsequent instruction word in order to supply the prefix operand to the subsequent instruction for operation.

In the context of instruction sets, certain instructions may use zero or more destination operands, and/or zero or more source operands. In some of those instructions a destination operand may be implicit or explicit, and further, a source operand may also be implicit or explicit. An explicit operand may be given as a field in the instruction. For. e.g., take the three operand add instruction: r1=addr2, r3; in this add instruction, destination r1 takes the result of the addition, and the source operands r2 & r3 supply the source values to add up. In some embodiments, this would require space for at least four fields in the instruction—an opcode field, a destination field and two source operand fields.

If an architecture and an associated computing machine are created to shorten the average instruction length to speed up processing, reduce power consumption, and increase performance per watt metrics, it may become necessary to either reduce the size of individual fields of an instruction or reduce the number of fields in an instruction or reduce both. If a class of instructions are designed such that a destination operand and a source operand are a same location and/or a same register, then one operand field can be eliminated. For e.g., a two-operand add instruction can become r1=add r2; representing thus, the high level construct r1+=r2; and where register r1 is both the destination register and one of the source registers. Sometimes for efficiency and performance reasons, a compiler or a programmer may prefer or require the former three operand add instruction also to be included in the instruction set. This increases the instruction opcode space and the complexity of a decoder that must have capability to decode both instructions.

This disclosure presents various embodiments of instruction operand prefix combining mechanisms that can convert a shorter (smaller) instruction with fewer or one kind of operand(s) into a longer instruction with more operands or into an instruction with a different kind of operand(s) prior to or during instruction decoding; otherwise, such conversion can also be done in a later stage. In the context of the exemplar add instructions discussed above, in some embodiment, the instruction operand prefix combining mechanism (for e.g., an operand prefixing mechanism using an instruction operand prefixing combinator or an operand prefixer or a prefix combinator) takes a prefix operand r3 in an operand prefix instruction ‘opfx r3;’ followed by a two operand add instruction ‘r1 add r2;’ and the ‘combinator’ (e.g., instruction operand prefixer or instruction operand prefixing combinator) combines the two instructions to present a three operand instruction ‘r1=add r3, r2;’ to the decoder or to latter stages. Thus, the implicit first source operand r1 is replaced by the source operand r3, thereby converting a two operand add instruction into a three operand add instruction in this embodiment. As used in here an instruction operand prefixing combinator (prefix combinator) comprises at least one pre-decoder, at least one operand selector, and at least one operand combining logic block, wherein the prefix combinator takes a prefix operand from an operand prefixing instruction and combines the prefix operand with a prefix operand consuming instruction (operand consuming instruction or consuming instruction) and creates a combined instruction which is executed.

In some embodiment, a same prefix instruction and a same operand prefixing mechanism can be used to convert similar operations from their two operand instruction forms to three operand instruction forms. This implies that in such an embodiment additional opcodes need not be reserved for the three operand instruction versions of the corresponding operations. For e.g., in case of subtraction, r1−=r2; (e.g., r1=sub r2;) may be converted using a prefix operand r3 into r1=r3−r2; (e.g., r1=sub r3, r2;).

In some embodiments, the prefix operand can be used to include a new source operand or a new destination operand into the operand consuming instruction (e.g., a receiving instruction or a consuming instruction) that follows. This can be implicit in the construction of the instruction set architecture and the associated machine. The choice of whether the prefix operand is a source operand or a destination operand or its position in the list of source or destination operands can be determined by the choice of the opcode associated with the prefix instruction and/or the opcode associated with the consuming instruction which follows the prefix instruction.

In some embodiments, the prefix operand can be used to replace a source register and/or a destination register of an operand consuming instruction with a new register that is larger in size than the previously designated source register or destination register. This allows mixed mode arithmetic between registers of two different lengths/sizes provided the conversion can be implicitly done. For e.g., in one embodiment, a long 64-bit value may reside in register x3 and a 32-bit integer value may reside in register r2; an add instruction that normally performs an operation r3+=r2, such as r3=add r2 can be converted into a mixed-mode instruction such as x1=add x3, r2, which performs the operation x1=x3+ (long) r2; this can be done merely by using a prefix instruction with prefix operand x1 that can change the behavior of the add instruction to perform mixed mode arithmetic also. Alternately, in some other embodiments the combined instruction may become x1=add r1, r2, wherein merely the destination size is changed and in this example the operation performed would be x1=(long)(r1+r2), effectively.

In yet some other embodiments, certain types of compressed instructions may use certain operands implicitly, wherein for e.g., a register r0 (or in some cases, for e.g., an accumulator, or the top of a stack) may be a default source operand or a second destination operand. Take for e.g., a compressed loop instruction ‘loop p5’, where ‘p5’ holds the address of a start of loop, and which may need a loop count value that may be stored in register r0. In this compressed loop instruction, register r0 is implicit (not an explicit field); however, register r0 is an implied source and an implied destination for a loop count decrement operation that occurs at least once per iteration of that loop. This form of this compressed loop instruction is a highly compressed form due to the implied operand r0 and this form may be suitable in some program sequences. However, if a compiler chooses to use any alternate register rk, where K may not be zero, for example register r5 instead of register r0 for holding a loop count value, then an additional field would be needed to execute the loop instruction using register r5. The operand prefix mechanism can be used in some embodiments to provide register r5 as a prefix operand to the compressed loop instruction. For e.g., a sequence “opfx r5; loop p5;” (where opfx is an operand prefix instruction mnemonic) would effectively do the job of a multi-operand loop instruction of the form ‘loop p5, r5’, where the loop count in register r5 is decremented per iteration and register r0 is not used at all. This would happen without a customized opcode for the multi-operand loop instruction, and by merely using a prefix instruction mnemonic and/or opcode of ‘opfx’ with the appropriate prefix operand as a predecessor to the loop instruction ‘loop p5’. Accordingly, one of ordinary skill in the art can appreciate that a prefix instruction with prefix operand can be used to considerably extend a pre-defined instruction set without adding many additional opcodes and without changing the length of the original native instruction word.

In the context of matrix operations, the instruction operand prefixing combinator is even more important, since the number of bits needed for the fields/operands used to perform certain matrix operations can exceed the size of a 32-bit instruction length or even a larger instruction length. For example, besides identification of operand matrices, possibly their bounds, it may also be needed to identify certain rows or columns or diagonals or sub-matrices of one or more of those matrices to perform certain operations. This may require prefixing not just one prefix operand but possibly multiple prefix operands in some order to construct a complete combined instruction from one or more smaller but fully well-defined instructions. For e.g., an add.matrix instruction that performs the operation ‘m5=m4+m3’, where m5, m4 and m3 refer to matrices, can be enhanced/expanded to “opfx row5, row4, row3; m5=m4+m3;” to perform an operation “add row#4 of matrix m4 and row#3 of matrix m3 and put the resulting row into row5 of matrix m5”. This can be done merely using a prefix instruction (e.g. a multi-operand prefix instruction) such as ‘opfx row5, row4, row3’ followed by ‘m5=m4+m3’.

In legacy implementations, a combined sequence of instructions has been implemented using compiler directives which would increase the code size when implemented as library function calls. In contrast, the current disclosure proposes a technique to compactly add operands to existing instructions to achieve a targeted functionality, yet without increasing the code size. The operand prefix mechanism as disclosed herein allows existing instructions to.be retargeted for specific sub-functions, e.g., the add matrix instruction discussed above. This allows easy instruction set extensibility and helps maintain backward compatibility of instruction sets.

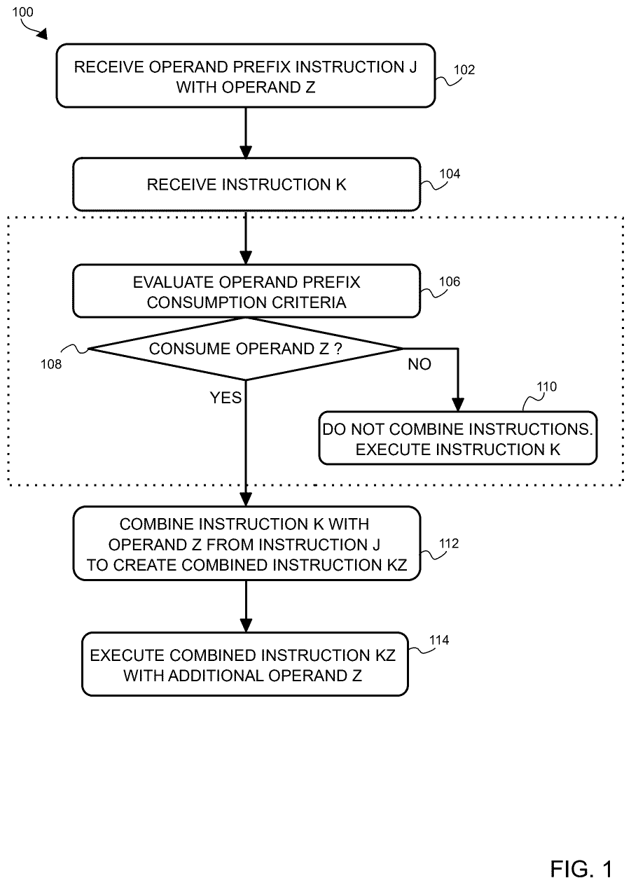

FIG. 1 illustrates an instruction operand prefixing technique, namely technique 100, in accordance with some possible embodiment. Optionally, technique 100 may be implemented in the context of any of the figures herein.

In the embodiment illustrated in FIG. 1, in step 102 of technique 100, an operand prefix instruction J with at least one prefix operand such as prefix operand Z is received in a buffer. In step 104 of technique 100, an instruction K (possibly a prefix-operand-consuming instruction K) (abbreviated as ‘consuming instruction’) is also received in the buffer. In step 106 of technique 100, at least one evaluation criterion is used to determine whether the instruction K is allowed to consume a prefix operand from the operand prefix instruction J. If the instruction K is determined as a ‘consuming instruction K’, then control proceeds to step 112; otherwise, if it is determined that instruction K is not a ‘consuming instruction’ then in step 110 the instruction J and Instruction K are not combined, and instruction K is executed as such. The operand prefix instruction J may be converted into a NOP (no operation) instruction and processed as such; otherwise, it may be processed differently (for e.g., an exception may be raised; and alternately, the behavior may be undefined, or the instruction J may be ignored, etc.). If an Instruction J preceding instruction K is not an operand prefix instruction, instruction J and instruction K would not be combined, and would be decoded, and executed as two successive instructions—instruction J and instruction K. The evaluation in step 106 and determination in decision 108 are included because not all instructions may be defined to consume a prefix operand such as prefix operand Z, while some other consuming instructions may be defined to consume a prefix operand.

In the context of this disclosure, a NOP (no operation) instruction is a field of bits that once decoded, merely causes the instruction pointer (e.g., program counter) to move to a next instruction.

If in step 106 and decision 108 it is determined that operand prefix instruction J and instruction K are to be combined, then in step 112 of technique 100, instruction K is combined with prefix operand Z from the operand prefix instruction J to create a combined instruction KZ. In step 114 the combined instruction KZ that includes operand Z is executed.

Another mechanism that has been used in legacy implementations to implement complex instructions is using micro-code where the user is allowed to create custom instructions using small micro-programs. The currently disclosed technique does not preclude such an underlying mechanism since it is orthogonal to how a user is expected to use the current technique of retargeting an instruction to consume additional operands using the operand prefixing mechanism herein.

In the context of the present description, an operand prefix instruction refers to a first machine executable bit sequence in an assembly based program given to a processing unit that supplies a source reference or a destination reference to a succeeding second machine executable bit sequence wherein the second machine executable bit sequence is operable as a stand-alone executable unit independent of the first machine executable bit sequence.

The provision of additional references from the operand prefix instruction may modify the functionality of the second instruction. In other words, an operand prefix instruction refers to an instruction with a prefix operand. For example, in various embodiments, an operand prefix instruction may include, but is not limited to, a prefix instruction with a single operand. Additionally, or alternatively, a prefix instruction may be a prefix instruction with multiple operands. In some embodiments, an operand prefix instruction may be ‘prefixed’ by another operand prefix instruction (or a sequence of operand prefix instructions) to gain multiple prefix operands which may be used with a succeeding prefix consuming instruction. This would make an operand prefix instruction also a prefix operand consuming instruction.

An operand prefix instruction functionality can also be modified to implement an ‘operand suffix instruction’ based mechanism. In some embodiments, the operand suffix mechanism includes a check for an instruction to see if a succeeding suffix instruction has been included or not. An operand suffix instruction would then follow or succeed an operand consuming instruction in a program sequence.

The following description of the embodiment(s) is merely exemplary (illustrative) in nature and is in no way intended to limit the invention, its application, or uses. Additionally, the invention may be practiced according to the claims without some or all of the illustrative information.

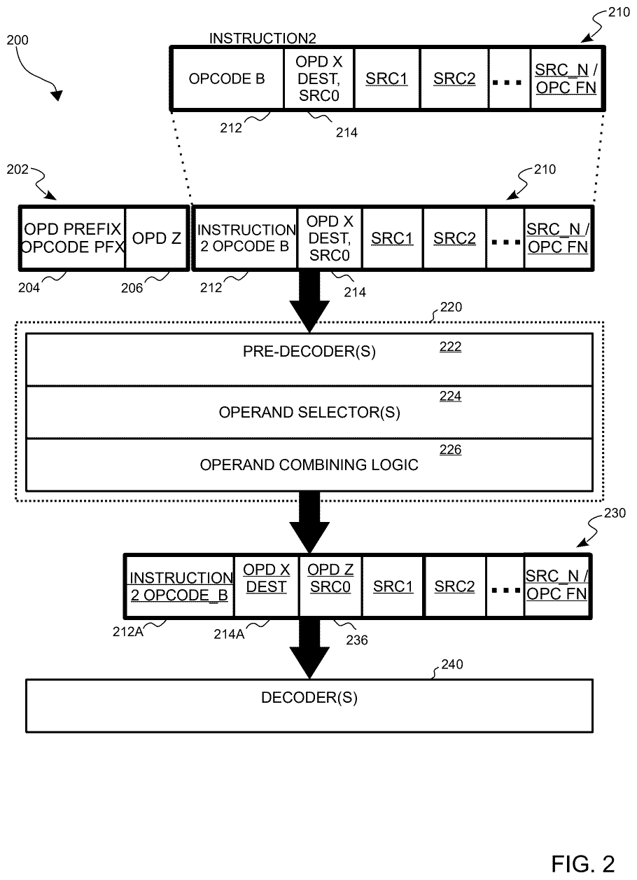

FIG. 2 illustrates an instruction operand prefixing combinator and decoder mechanism 200, in accordance with one possible embodiment. Optionally, the instruction operand prefixing combinator and decoder mechanism 200 may be implemented in the context of any of the foregoing figures.

In the embodiment of FIG. 2, in a computing machine with one or more processors in communication with a non-transitory memory, where at least one of the one or more processors comprises the instruction operand prefixing combinator and decoder mechanism 200 that comprises a buffer that receives instructions of the computing machine from a memory. The instructions of the computing machine comprise a first instruction 202 and a second instruction 210, and wherein the first instruction may be an operand prefix instruction comprising a first operand, and the second instruction may be any instruction capable of consuming a prefix operand from an operand prefix instruction. At least one of the one or more processors executes instructions of the computing machine.

The embodiment in FIG. 2 further comprises an operand prefix identifying mechanism that identifies the operand prefix instruction and determines the first operand, and an operand selection mechanism that selects the first operand and combines the first operand with at least some portion of the second instruction to create a combined instruction 230. The combined instruction 230 is decoded and processed. In some embodiments, the operand prefix identifying mechanism can be implemented in hardware. In some other embodiments, the operand prefix identifying mechanism may be implemented in microcode at least in part. In some further embodiments the operand prefix identifying mechanism is a prefix instruction identifying pre-decoder.

In some aspects, the first operand (prefix operand) serves as a destination operand of the combined instruction; while in some other aspects the first operand (prefix operand) serves as a source operand of the combined instruction.

In the embodiment of FIG. 2, in the instruction operand prefixing combinator and decoder mechanism 200, the first instruction 202 may comprise a prefix opcode 204 (for e.g., operand prefix opcode PFX) and a prefix operand 206 (prefix operand OPD_Z). The second instruction 210 (e.g. INSTRUCTION 2) may comprise an instruction opcode 212 (for e.g., OPCODE B, an opcode for operation B), at least one operand 214 (for e.g., an operand X which may be a destination operand DEST and/or a source operand SRC0), and additionally, one or more operands such as SRC1, SRC2, etc.; the second instruction 210 may further comprise a field which may be an opcode function (e.g., OPC FN) or an operand SRC_N, etc. The first instruction and the second instruction are fed to an instruction operand prefixing combinator 220 comprising a set of one or more pre-decoder(s) that includes at least one pre-decoder 222, a set of operand selector(s) that includes at least one operand selector 224, and one or more operand combining logic block(s) that include at least one operand combining logic block 226.

The set of pre-decoders with at least one pre-decoder 222 evaluate the first instruction 202 and the second instruction 210, and wherein the first instruction 202 is evaluated to determine whether it is an operand prefix instruction; and wherein the second instruction 210 is evaluated to determine whether it is an operand consuming instruction that can receive a prefix operand such as the prefix operand 206 (operand OPD_Z). Upon an affirmative confirmation from an evaluation of one or more operand prefixing and/or consumption criteria, a control signal (e.g., an operand selection control signal) controlling the at least one operand selector 224 from the set of the one or more operand selectors is asserted by the at least one pre-decoder 222.

The at least one operand selector 224 selects one of two operands from the set of operands containing the prefix operand 206 and instruction operands such as the at least one operand 214. In the event there are multiple prefix operands, one or more prefix operands would also be included in the selection set. If the control signal (e.g., the operand selection control signal) asserts selection of the prefix operand 206 then the operand selector selects the prefix operand 206 (operand OPD_Z) and passes it to the at least one operand combining logic block 226.

The at least one operand combining logic block 226 receives the second instruction 210 and one or more prefix operands (e.g., the prefix operand 206) and combines them to create a combined instruction 230 (in a prefix combining operation). The combined instruction 230 may have one or more additional operands 236 over the consuming instruction such as the second instruction 210 (consuming instruction). In some cases, one or more operands of the second instruction 210 (consuming instruction) may be replaced by the one or more prefix operands (e.g., the prefix operand 206). In some cases, in response to the selection of the first operand, the combined instruction gains an additional operand 236 over the second instruction. Combined instruction 230 comprises instruction opcode 212A and destination operand (OPD X) 214A inherited from the consuming instruction such as the second instruction 210.

The combined instruction may be stored in a buffer or a latch stage or may be directly provided as an input to one or more decoders (for e.g., instruction decoders) that include at least one decoder 240 for further decoding, processing, and further execution. In some embodiments the combined instruction may be scheduled as if it were the original second instruction, and in such embodiments the combined instruction may be retired as if it is the original second instruction. In some other embodiments the combined instruction may be executed in lieu of the first and second instructions.

In some other embodiments, the combined instruction and the first instruction, both may be presented to the one or more decoders such as the at least one decoder 240. The at least one decoder 240 may treat the first instruction 202 (which is the operand prefix instruction) as equivalent of a NOP (no operation) instruction since the prefix operand 206 (prefix operand OPD_Z) is combined to form the combined instruction 230. In some embodiments the both the first instruction 202 (the operand prefix instruction) which is transformed or relegated as a NOP instruction, and the combined instruction may be executed and then retired.

In some other embodiments, the first instruction (e.g., operand prefix instruction) transformed to or relegated as a NOP instruction after the prefix combining operation, may be suppressed and/or discarded without further scheduling during decoding or farther on. In some other embodiments, the first instruction is not scheduled for execution, and only the “second” instruction or the combined instruction may be scheduled for execution. Consequently, the first instruction is not executed after creation of the combined instruction.

In embodiments where both the first instruction (possibly transformed to become equivalent of a NOP instruction) and the combined instruction (primarily derived from the second instruction) are decoded and scheduled, any interrupts and exceptions may be handled as known in the art, whereas in other embodiments interrupt and exceptions are handled in a manner that is consistent with the embodiments.

In some embodiments where the first instruction transforms to become equivalent of a NOP instruction, and is suppressed or discarded during or after decode, the interrupts and exceptions may use the second instruction (and/or the combined instruction derived/obtained from the second instruction) as the marker instruction; and any concurrent interrupts or exceptions may be recorded as if they occurred either before or after the execution of the combined instruction depending on the nature of the interrupt or exception. The combined instruction 230 itself may cause an exception including traps, aborts, faults, failures, etc., to occur because of execution or an execution attempt.

The foregoing discusses a particular class of instruction operand prefixing combinators which are merely for illustration and are by no means exhaustive of all implementations. The following figures are being presented as example implementations.

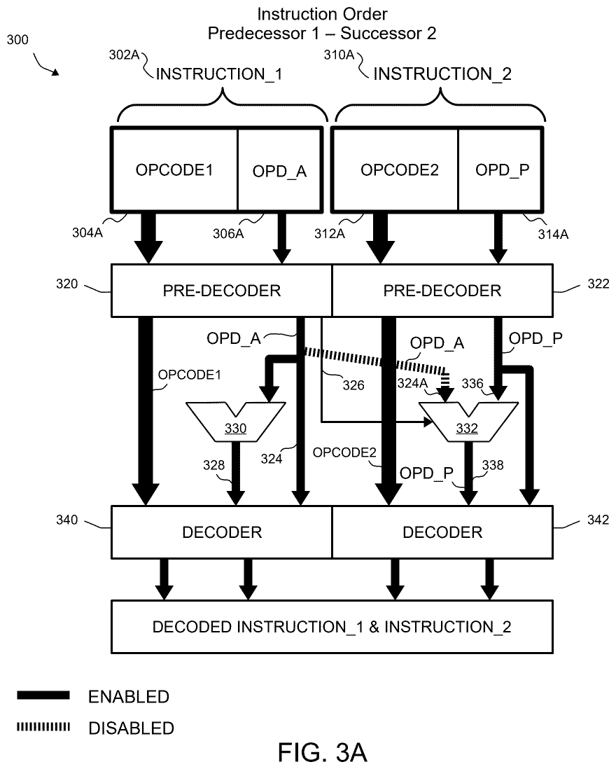

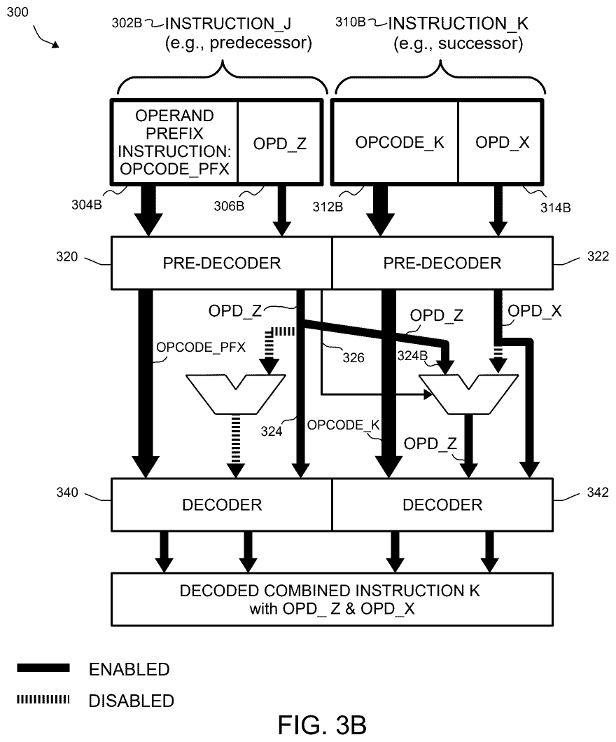

FIG. 3A and FIG. 3B illustrate a comparison of processing flows of two adjacent instructions through an instruction operand prefixing combinator and decoder 300, in accordance with one possible embodiment. Optionally, the processing flows of the two adjacent instructions through the instruction operand prefixing combinator and decoder 300 may be implemented in the context of any of the foregoing figures.

In the embodiment of FIG. 3A, a first instruction 302A and a second instruction 310A are presented to a set of corresponding pre-decoders comprising at least one instance of a pre-decoder 320 and a second pre-decoder 322. The first instruction 302A (INSTRUCTION_1) comprises at least one opcode 304A (OPCODE1) and zero or one or more operands. In this example of the flow, the first instruction 302A is shown with one operand 306A (OPD_A). In FIG. 3A, the second instruction 310A (INSTRUCTION_2) comprises an opcode 312A (OPCODE2) and zero or one or more operands. In FIG. 3A, the second instruction 310A comprises one operand 314A (OPD_P). In this example flow, first instruction 302A is not an operand prefix instruction and hence first instruction 302A (INSTRUCTION_1) does not source a prefix operand to second instruction 310A (INSTRUCTION_2). First instruction 302A and second instruction 310A are pre-decoded by the pre-decoder 320 and the second pre-decoder 322 respectively, and it is determined that first instruction 302A (INSTRUCTION_1) is not an operand prefix instruction. Upon this determination the pre-decoder 320 de-asserts the control signal 326 to indicate that the first instruction 302A is not an operand prefix instruction which would cause a multiplexer 332 to select data input 336 carrying operand OPD_P to be sent to the multiplexer output 338 that is coupled to instruction decoder 342. Multiplexer 330 with output 328 may be controlled separately by a previous stage pre-decoder (not shown in figure). In this instance of the flow, the data input 324A coupled to data bus 324 is effectively rendered disabled or disconnected (unselected) by the control signal 326.

Instruction decoder 340 decodes INSTRUCTION_1 (OPCODE1 and OPD_A) and instruction decoder 342 decodes INSTRUCTION_2 (OPCODE2 with operand OP_P). Decoded INSTRUCTION_1 and decoded INSTRUCTION_2 may be forwarded for further processing, or they may be first stored after decoding in a buffer or registers or a latch stage and then are forwarded for further processing.

In the processing flow in the embodiment of FIG. 3B, a first instruction 302B (operand prefix instruction INSTRUCTION_J) and a second instruction 310B (operand consuming instruction INSTRUCTION_K) are presented to a set of corresponding pre-decoders comprising a pre-decoder 320 and a second pre-decoder 322. The first instruction 302B comprises at least one opcode 304B (OPCODE_PFX) for an operand prefix instruction, and one or more operands such as prefix operand 306B. In this example of the flow in the embodiment of FIG. 3B, the first instruction 302B is shown with one operand which is a prefix operand 306B (OPD_Z), and the second instruction 310B comprises an opcode 312B (OPCODE_K) and zero or more operands. In this example of FIG. 3B the second instruction (INSTRUCTION_K) comprises an operand 314B (OPD_X). First instruction 302B is an operand prefix instruction and hence first instruction 302B (INSTRUCTION_J) sources the prefix operand 306B (OPD_Z) to second instruction 310B (INSTRUCTION_K). First instruction 302B and second instruction 310B are pre-decoded by the pre-decoder 320 and the second pre-decoder 322, respectively, and it is determined that first instruction 302B (INSTRUCTION_J) is indeed an operand prefix instruction. Upon this determination the pre-decoder 320 asserts the control signal 326 to indicate that the first instruction 302B is an operand prefix instruction causing the multiplexer 332 to select data input 324B (coupled to data bus 324) carrying operand OPD_Z to be sent to the multiplexer output 338 which is coupled to instruction decoder 342.

Instruction decoder 340 decodes INSTRUCTION_J and instruction decoder 342 decodes a combined instruction: INSTRUCTION_K with operands OPD_Z and OPD_X (a version of INSTRUCTION_K with additional operand). Decoded INSTRUCTION_J and decoded combined instruction INSTRUCTION_K may be forwarded for further processing, or they may be stored after decoding in a decoder output buffer or decoder output registers or decoder latch stage before they are forwarded for further processing. Operand prefix instruction INSTRUCTION_J may be decoded by instruction decoder 340 as equivalent to a NOP (No Operation) instruction since its primary functionality is considered completed at this decode stage.

If during the processing flow in the embodiment of FIG. 3B, an interrupt or fault or a trap or a failure occurs, the restart point may be determined by taking the operand prefix instruction such as the first instruction 302B (INSTRUCTION_J) and the operand consuming instruction such as second instruction 310B (INSTRUCTION_K) together. This implies that in some cases the restart of the original program flow happens by repeating the INSTRUCTION_J and INSTRUCTION_K flows at least in part. In other cases, the restart of the original program flow may happen with an instruction that may be a successor to INSTRUCTION_K. In one embodiment, when an exception occurs after instruction INSTRUCTION_J and prior to instruction INSTRUCTION_K, the exception is handled after instruction INSTRUCTION_K. The preferred embodiment does not preclude restart with just the INSTRUCTION_K, if operand OPD_Z is stored along with the state of the machine needed for restart.

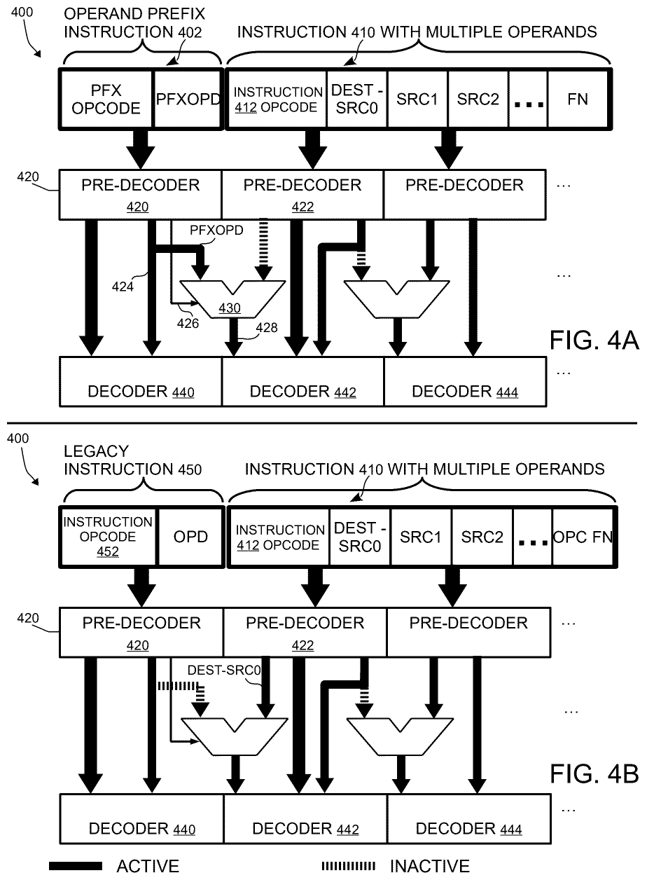

FIGS. 4A and 4B illustrate examples of instruction flows for processing two adjacent instructions through operand prefixing combinators in a multi-operand instruction scenario. The FIG. 4A depicts operand prefixing to a multi-operand instruction in a parallel instruction operand prefixing combinator and instruction decoder, in accordance with one possible embodiment. The instruction flow in FIG. 4B depicts instructions passing through without prefixing, via the parallel instruction operand prefixing combinator and instruction decoder. Optionally, the techniques of processing two adjacent instructions through the parallel instruction operand prefixing combinator and instruction decoder may be implemented in the context of any of the foregoing figures.

In the example flow of FIG. 4A, in the embodiment 400 of parallel instruction operand prefixing combinator and instruction decoder, an operand prefix instruction 402 comprising an operand prefix opcode (e.g., PFX opcode) and a prefix operand (e.g., PFXOPD) are received in a buffer. An instruction 410 comprising at least one instruction opcode such as instruction opcode 412 and at least one destination operand DEST along with one or more source operands SRC0, SRC1, SRC2, etc., is received. The destination operand DEST and the source operand SRC0 may refer to the same reference and/or location. The instruction 410 may further comprise other fields such as source references (e.g., SRC1, SRC2) and opcode functions (e.g., FN).

In the example flow of FIG. 4A, in embodiment 400, the operand prefix instruction 402 and the instruction 410 are inspected by a prefix operand identifying mechanism implemented using one or more parallel pre-decoders such as pre-decoder 420 to identify a prefix instruction. The pre-decoder 420 upon identifying the operand prefix instruction 402 asserts operand select signal 426 causing a multiplexer 430 to select operand PFXOPD over operand bus 424 which is passed to the multiplexer output 428 that is coupled to decoder 442. Decoder 442 also receives the instruction opcode 412 of instruction 410 and operand DEST-SRC0. Decoder 444 may receive other operands of instruction 410. In some embodiments, operand PFXOPD may be used in lieu of SRC0 while the destination operand remains DEST. In some other embodiments, operand PFXOPD may be used in lieu of operand DEST as the destination operand, while the operand DEST-SRC0 is used as the zeroth source operand (SRC0). Decoder 442 and decoder 444 together decode the combined instruction formed by combining (fusing) the instruction 410 and operand PFXOPD. Decoder 440 decodes the operand prefix instruction 402 and treats the operand prefix instruction 402 as equivalent to a NOP instruction.

In contrast when two legacy instructions are presented to embodiment 400 the FIG. 4B shows an example flow of the instructions passing through the parallel instruction operand prefixing combinator and parallel instruction decoder without prefixing. In FIG. 4B, a legacy instruction 450 with a legacy instruction opcode 452 and a following instruction 410 are received in a buffer and inspected by pre-decoder 420 and pre-decoder 422. Pre-decoder 420 inspects the legacy instruction opcode 452 and determines that legacy instruction 450 is not an operand prefix instruction. Consequently, pre-decoder 420 de-asserts operand select signal 426 which causes the multiplexer 430 to select operand DEST-SRC0 to proceed to multiplexer output 428. Decoder 442 coupled to multiplexer output 428 receives operand DEST-SRC0. Decoder 442 also receives the instruction opcode 412. Decoder 442 and decoder 444 together decode the instruction 410 with multiple operands. Legacy instruction 450 is decoded by decoder 440.

The following description of the embodiment(s) is merely exemplary (illustrative) in nature and is in no way intended to limit the invention, its application, or uses. Additionally, the invention may be practiced according to the claims without some or all of the illustrative information.

A machine architecture comprises an embodiment of a set of one or more machine instructions of an instruction set architecture implemented in the context of a processing unit. In the context of this description the terms instruction and machine instruction are used interchangeably; an embodiment of a computer program comprises one or more sequences of machine instructions in a program sequence, which sequences hereinafter are referred to as instructions in the program sequence or instruction sequences.

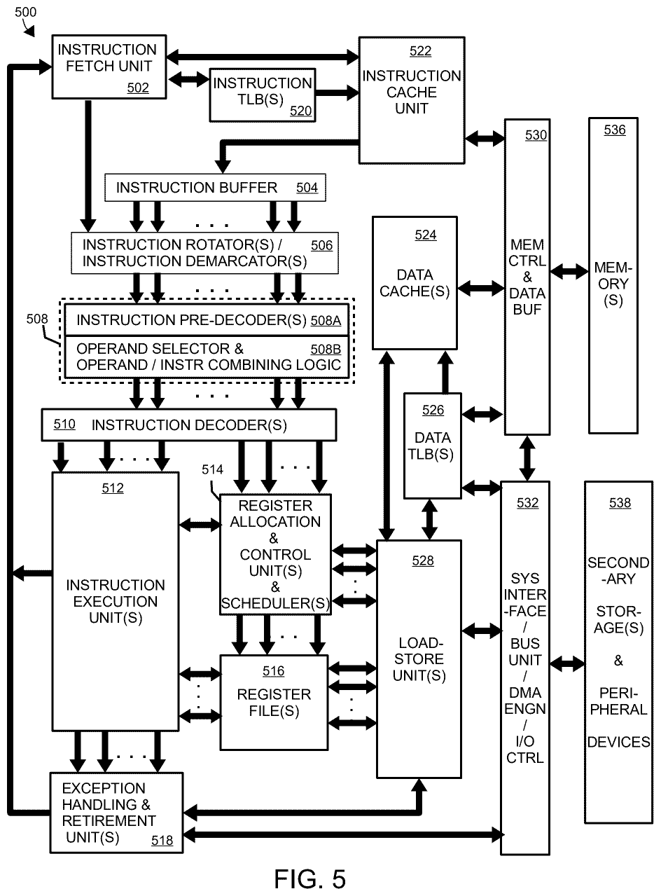

FIG. 5 illustrates a computing system comprising one or more instruction operand prefixing combinators and decoders, in accordance with one possible embodiment. Optionally, the computing system with a processing unit 500 comprising processing units with one or more instruction operand prefixing combinators and decoders may be implemented in the context of any of the foregoing figures.

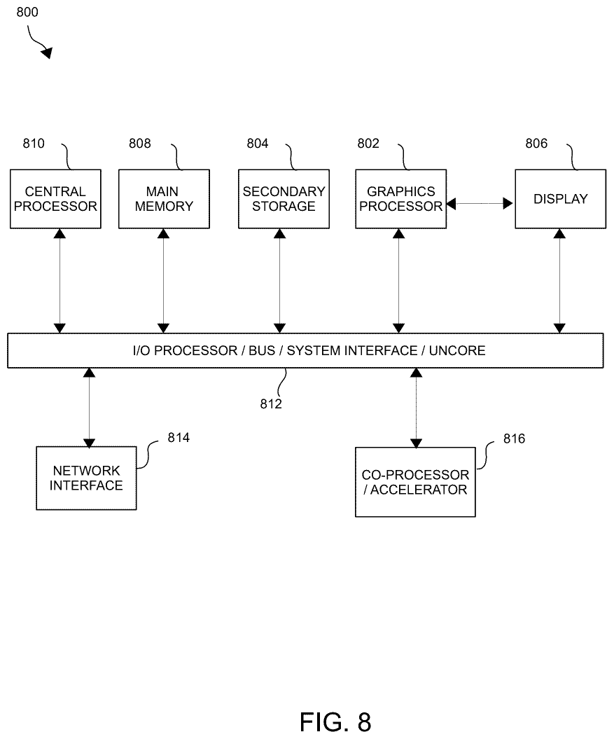

The computing system with processing unit 500 may be used for computation, control, graphics, communication and/or any form of data processing including machine learning in some embodiment. The processing unit 500 (referred to as a central processor in some embodiments) can be used in a system (such as FIG. 8) comprising a system memory, a storage, and other components in accordance with some embodiments for one or more applications.

In the embodiment shown in FIG. 5, the processing unit 500 comprises one or more instances of instruction fetch unit 502 coupled optionally to one or more instances of instruction cache unit 522. Instruction fetch unit 502 may optionally work in conjunction with an instruction translation lookaside buffer 520 and/or with a branch prediction logic in some embodiments.

In some embodiments the processing unit 500 also comprises one or more instances of instruction buffer 504 which may be coupled to one or more instances of instruction demarcator 506 or an instruction rotator.

Instruction fetch unit 502 may control and/or cause instruction sequences to be fetched from system memory such as memory 536 and/or instruction cache unit 522 or from some storage area (not shown) into the instruction buffer 504. The instruction demarcation logic in instruction demarcator 506 may partially or completely demarcate instruction sequences into one or more individual instructions. The individual instructions are presented in program sequence to one or more instruction operand prefix combinator(s) 508 comprising one or more instruction pre-decoders 508A and operand selector and operand combining logic 508B. The instructions are decoded by instruction decoder(s) 510 after any operand prefixing operation. The decoded instructions are sent for execution thereafter.

Processing unit 500 may also comprise one or more instances or variations of instruction execution unit 512 which comprise different variations of logic units to perform various different arithmetic, logic and other computations including truncation, sign-extension, and zero-extension operations. An instruction execution unit 512 may also perform branch target determination and branch related computations or may work in conjunction with a branch unit (not shown) that performs such and related functions. Processing unit 500 may also comprise one or more instances of register allocation and control unit (RAC 514), controlling one or more instances of register file 516. Optionally, in some embodiments, RAC 514 may comprise or work in conjunction with a re-order buffer (ROB) (not shown) and other control logic such as a scoreboard logic (not shown) for instruction and operand scheduling. Some embodiments may include one or more instruction scheduler(s) to schedule and control instruction execution in RAC 514 in the processing unit.

Processing unit 500 further comprises one or more load and store unit(s) (LSU) 528 which may be coupled to the instruction execution unit 512 and RAC 514 and register file 516. Processing unit 500 may further comprise a data cache unit (DCU) 524 and one or more data translation lookaside buffer(s) 526, and a system interface unit 532 (also called a bus unit). The processing unit 500 also comprises one or more unit(s) 518 for exception handling including interrupts, instruction retirement and branch control. The system interface unit 532 may further comprise logic to control and access one or more internal and external interfaces, modules and/or components such as one or more instances of memory controller 530, one or more I/O controllers (IOC) one or more interrupt controllers (included in unit(s) 518), one or more co-processors (not shown), one or more graphics interfaces (not shown) and display control units (not shown), one or more security processor units (not shown), one or more power controllers (not shown), one or more machine control and system configuration units (not shown), one or more test controllers (not shown), one or more internal and/or external transport interfaces, etc. In many embodiments the instruction cache unit 522 and data cache unit (DCU) 524 are coupled to the system interface unit 532. The memory controller 530 controls and interfaces with one or more memories 536. The system interface unit 532 is coupled to secondary storage and other peripherals 538.

In some embodiments, one or more instances of the instruction operand prefixing combinators and decoders may be used inside some of the units associated with the system interface or other modules such as a co-processor, a machine controller, a security processor, a power controller, a test controller, a packet processor, etc. FIG. 5 merely illustrates one possible embodiment where an instruction operand prefixing combinator and decoder may be used as configured. However, instruction operand prefixing combinators and decoders may be used in any other configuration in example embodiments that may include but not be limited to a graphics processor, a signal processor, a neuromorphic or machine learning processor, a matrix and array processor, an application specific field programmed processor on an FPGA, a string processor, a network processor, a packet processor, a stream processor, a baseband processor, a VLIW machine, a micro-controller, a micro-sequencer, a binary translator, a co-processor, etc. Further, these example embodiments may be embedded or standalone modules or components.

Further, the instruction operand prefixing combinators and decoders may be implemented in any technology, be it using any semiconductor technology such as silicon, silicon-germanium, silicon on insulator (SOI), etc., or in a system or device using newer technologies such as quantum computing or optical computing or spintronics; or it may even be implemented as a computer program product such as in a binary translation program product. In some embodiments, the instruction operand prefixing combinators and decoders may be implemented in microcode, at least in part.

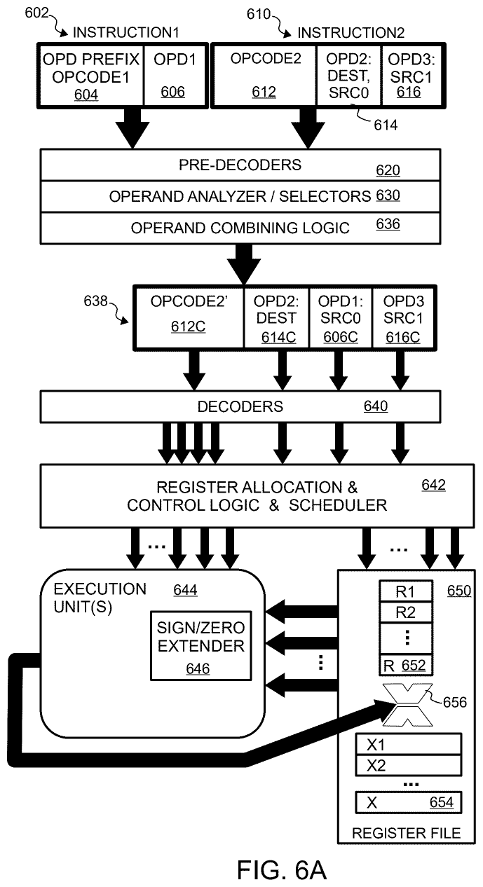

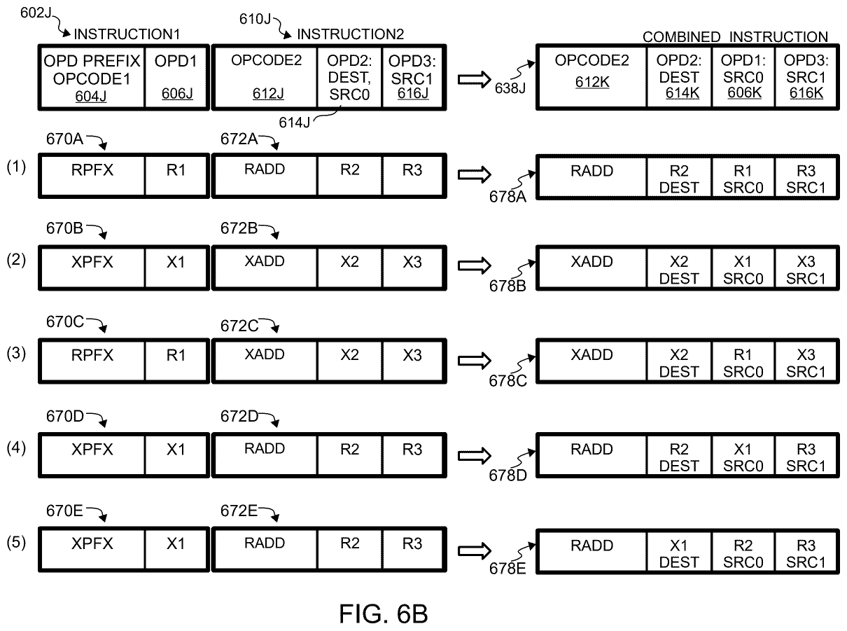

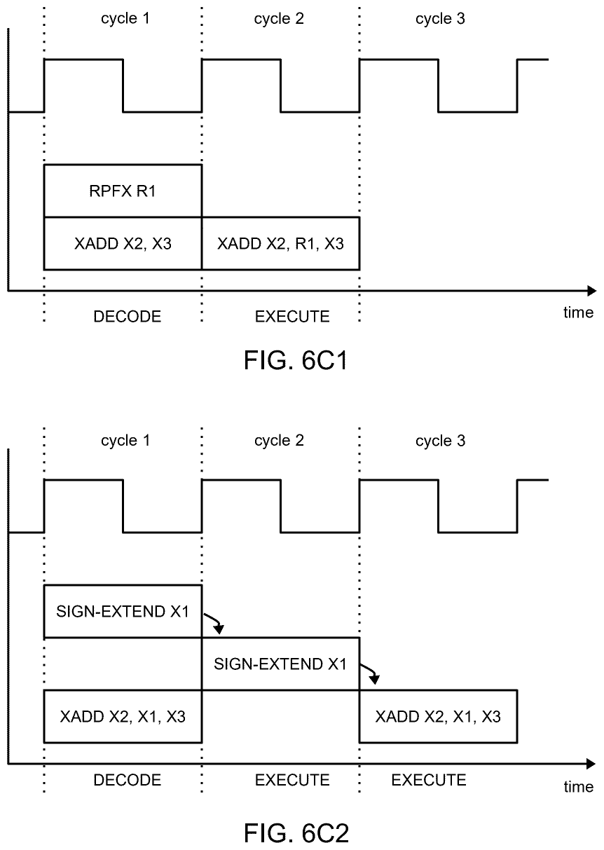

FIG. 6A illustrates an instruction execution path to execute a combined instruction comprising a prefixed operand, in accordance with one possible embodiment. Optionally, the instruction execution path of FIG. 6A may be implemented in the context of any of the foregoing figures. FIG. 6A is being presented to illustrate examples of how mixed mode arithmetic instructions can be created and executed using operand prefixing mechanisms.

In the embodiment of FIG. 6A, an operand prefix instruction 602 (INSTRUCTION1) comprising operand prefix opcode 604 (OPCODE1) and a prefix operand 606 (OPD1) is presented to pre-decoders 620 along with instruction 610 (INSTRUCTION2). In this example, Instruction 610 comprises an opcode 612 (OPCODE2), an operand 614 (OPD2) which acts as both the destination operand and the first source operand in instruction 610. Instruction 610 further comprises a second source operand 616 (OPD3 as SRC1). The pre-decoders 620 determine that instruction operand such as prefix operand 606 OPD1 be combined with instruction 610 (INSTRUCTION2). The operand selectors 630 select the prefix operand 606 (OPD1) to combine with instruction 610 (INSTRUCTION2), and the operand combining logic 636 combines the operand OPD1 and INSTRUCTION2 to produce a combined instruction 638. The combined instruction 638 comprises the opcode 612C (OPCODE2) inherited from the opcode 612 (OPCODE2), destination operand 614C (OPD2 as DEST), source operand 606C (OPD1 as SRC0) and the second source operand 616C (OPD3 as SRC1). The instruction 610 (INSTRUCTION2), originally a two operand instruction, is now morphed into a three operand form in the combined instruction 638.

The combined instruction 638 proceeds through the execution path and is decoded as a three operand combined instruction by decoder(s) 640 and a decoded instruction at the output of the decoder is forwarded for execution. The decoded instruction is used by an optional register allocation unit in control block 642 to determine physical registers to use as per the program sequence. The decoded instruction may be scheduled by an optional scheduler in the control block 642. The decoded instruction is eventually used to read source operand values from a register file 650. In some embodiments, register file 650 may comprise word-width registers native to an architecture such as register 652 (R register). In some further embodiments, register file 650 may also optionally comprise extended-width registers such as extended-register 654 (X-register). In addition, in some embodiments, other kinds of register(s) such as floating point register(s), vector register(s) and/or matrix register(s) may also be part of the register space covered by the instructions such as operand prefix instruction 602, instruction 610, and the combined instruction 638.

In a computing machine, a consuming instruction may take a word wide register such as register 652 (R register) as a source operand, and also as a destination operand, and the consuming instruction may be modified in response to a first instruction such that the combined instruction generates an extended word length result which may be written into an extended word length register such as extended-register 654 given by a first operand (prefix operand) from the first instruction.

The register file 650 may also comprise a register-file I/O interface and decoder logic 656 to select the source and destination operand registers and to read and write data. The decoded instruction may use any designated register from register file 650 to perform any operation associated with the combined instruction 638. The operation itself is performed by reading the register operand values and any other associated values into the one or more instances or variations of execution unit 644 that use the decoded instruction (and decoded OPCODE2) to generate at least one result value. The result value(s) may be written into a register or an extended register (or any other kind of register, e.g., a register pair) in the register file 650 as specified by the destination operand DEST in the combined instruction 638. In some embodiments, the execution unit 644 may optionally contain a sign/zero-extender unit 646 which may be used in some mixed mode arithmetic operations.

FIG. 6B illustrates several example embodiments of combined instructions and the corresponding functionality. FIG. 6B also illustrates examples of how mixed mode arithmetic instructions can be created and executed using operand prefixing mechanisms.

Example (0) is an illustration of the instructions from FIG. 6A. It illustrates that instruction 602J (INSTRUCTION1), an operand prefix instruction, is combined with instruction 610J (INSTRUCTION2) to generate combined instruction 638J. Example embodiments (1) through (5) illustrate how the combined instructions may be interpreted for execution by various machine embodiments as they relate to the example execution path embodiment illustrated in FIG. 6A.

In example embodiment (1) of FIG. 6B, a register operand prefix instruction 670A (RPFX R1;) with opcode RPFX and prefix operand R1 is combined with a register add instruction 672A (RADD R2, R3). In this example, the registers R1, R2 and R3 have a word length as defined by the architecture of the particular embodiment. The register add instruction 672A may functionally perform an operation such as R2:=R2+R3. The combined instruction 678A, obtained after combining the prefix operand R1 with the register add instruction 672A may become a three operand instruction such as RADD R2, R1, R3; and which has the functionality such as R2:=R1+R3.

In example embodiment (2) of FIG. 6B, an extended-register operand prefix instruction 670B (XPFX X1;) with opcode XPFX and an extended-register prefix operand X1 is combined with an extended-register add instruction 672B (XADD X2, X3) to generate a three operand combined instruction 678B (XADD X2, X1, X3). In the combined instruction the extended-register X2 is a destination extended-width-register and extended-register X1 and extended-register X3 are extended-width source registers. In this example embodiment, an extended width register is a long word register (for e.g., the extended-register 654 in FIG. 6A). The extended-registers may have widths different from the other word registers. The functionality of the three operand combined instruction 678B (XADD X2, X1, X3) would be to perform an operation such as X2:=X1+X3. In some embodiments the operand prefix may be used for a floating point register operand and may affect floating point instructions and operations.

The following example embodiments illustrate how mixed mode arithmetic instructions can be created to perform operations on groups of unequal size operands or dissimilar type operands using operand prefix instructions and existing arithmetic, logical, bit-manipulation, and even text and ASCII/character string instructions or any other instruction kinds.

In example embodiment (3) of FIG. 6B, a register operand prefix instruction 670C (RPFX R1;) with register prefix operand R1 is combined with an extended-register add instruction 672C (XADD X2, X3), to create a mixed arithmetic combined instruction 678C (XADD X2, R1, X3). The mixed arithmetic combined instruction 678C adds a word length register R1 to an extended word length register X3 and places the result into extended-register X2 in the operation: X2:=X3+(XWORD) R1. An implicit size and type conversion of a word operand R1 into an extended-word (XWORD) operand is functionally carried out along the execution path shown in FIG. 6A during execution of the mixed arithmetic combined instruction 678C. The type and/or size conversion may involve zero-extension or sign-extension of the value of the word length register operand R1 in order to make it of type XWORD. Here XWORD is merely an example type and may correspond to any of the types commonly used in programming languages that an X register may hold. If in one embodiment floating point and integer operands are used in an operation, then an integer type to floating point type conversion and/or a floating point type to integer type conversion may be needed. In the embodiment in FIG. 6A, the sign-extension and/or zero-extension may be done using the sign/zero-extender unit 646 in the EXE module.

In the context of the execution path in the embodiment of FIG. 6A, during execution of the mixed arithmetic combined instruction 678C (FIG. 6B), the extended-register X3 (not shown) and the register R1 are read from the register file 650. The value from register R1 is sign-extended to the length of the X register in the sign/zero-extender unit 646 and then the addition operation is performed in the execution unit 644. The result is stored in the extended-register X2 of the register file 650. Thereafter, the register operand prefix instruction 670C and the extended-register add instruction 672C are both retired. In some embodiments, after combining the two instructions, the register operand prefix instruction 670C and the extended-register add instruction 672C may together be treated as a single instruction, and scheduled, executed, and retired accordingly.

Example embodiment (4) of FIG. 6B, illustrates a scenario that contrasts with the example (3). In example embodiment (4), instruction 670D, an extended-register operand prefix instruction (XPFX X1) is combined with a register add instruction 672D (RADD R2, R3) to produce/generate a combined instruction 678D (RADD R2, X1, R3). The combined instruction 678D is used to perform mixed-mode arithmetic by first converting an extended word value of operand X1 into a word value to perform a register add operation. The combined instruction performs the operation: R2:=(WORD) X1+R3. Conversion of an extended-word value into a smaller size word value may be done by truncation inside the execution unit 644. The result value of the instruction is stored in a destination R register R2 (DEST) in the register file 650.

In some embodiments, a variation of mixed-mode arithmetic may be implemented as in example embodiment (5). In example embodiment (5), an operand prefix instruction 670E (XPFX X1) provides the final destination operand and the register add instruction 672E (RADD R2, R3) that adds two word-length registers (register R2 and register R3) which are the first and second source operands. The operand prefix instruction 670E and the register add instruction 672E are combined and the combined instruction 678E (RADD X1, R2, R3) is decoded and executed. The combined instruction adds two word length values in R registers and stores the result in an extended-register X1. In response to the operand prefix instruction 670E the combined instruction 678E performs the following mixed-mode functionality: X1:=(XWORD) (R1+R2). The conversion of the result value from the size and type of a word to an XWORD may be done using the sign/zero-extender unit 646. A variation of this may be implemented in some embodiments where the operation associated with the combined instruction may be expressed as: X1:=(XWORD) R1+(XWORD) R2. The result of the addition is stored into a destination extended-register X1 in the register file 650.

The same mechanism can be extended to perform mixed mode fixed point arithmetic between integers and fixed point numbers or between fixed point type numbers of different bases, for example Q16 numbers and Q32 numbers, and so on. The operand prefixing combinator can also be extended to mixed mode operations with floating point numbers and integers by coupling the operand prefixing combinator to a floating point unit, where the execution stage hardware will be in the floating point unit. Mixed mode arithmetic between floating point type numbers and fixed point type numbers may also be performed in a similar manner, where a fixed point number can be converted into a floating point number based on the instruction opcode or using additional parameters, and by adjusting the exponent.

FIG. 6C1 and FIG. 6C2 illustrate example timing diagrams contrasting instruction execution in the disclosed mechanism and instruction execution in a legacy implementation, respectively, in accordance with one possible embodiment. The timing diagram in FIG. 6C1 illustrates how in the disclosed mechanism a prefix instruction RPFX R1 and an extended register add instruction XADD X2, X3 are combined and decoded in a single cycle 1 and executed as a single combined mixed-mode arithmetic addition instruction XADD X2, R1, X3 in cycle 2.

In contrast, in the legacy implementation with the timing diagram in FIG. 6C2, a word value residing in an extended word register is first sign-extended into an extended-word value using a sign-extension instruction. In many legacy implementations even more instructions may often be used to first left shift a word value in an extended register followed by an arithmetic right shift to cause sign extension. Thereafter, the extended word addition is performed. The instructions for sign extension or arithmetic right shift are decoded in cycle 1. The extended register add instruction may also be decoded in cycle 1. In cycle 2, the sign-extension or arithmetic right shift operation may be performed and after completion of the sign extension or arithmetic right shift operation, in cycle 3 the extended register add operation may be performed. It may be seen from the comparison of FIGS. 6C1 and 6C2 that the operand prefixing mechanism can potentially save computing cycles for mixed mode arithmetic and improve performance over legacy implementations.

It may be noted that all the above example embodiments may be implemented at least in part in hardware and/or at least in part in microcode. While specific embodiments of the invention have been described, it is understood that the present invention is not intended to be limited only to such embodiments. The description of the embodiment(s) is merely exemplary (illustrative) in nature and is in no way intended to limit the invention, its application, or uses. Additionally, the invention may be practiced according to the claims without some or all of the illustrative information.

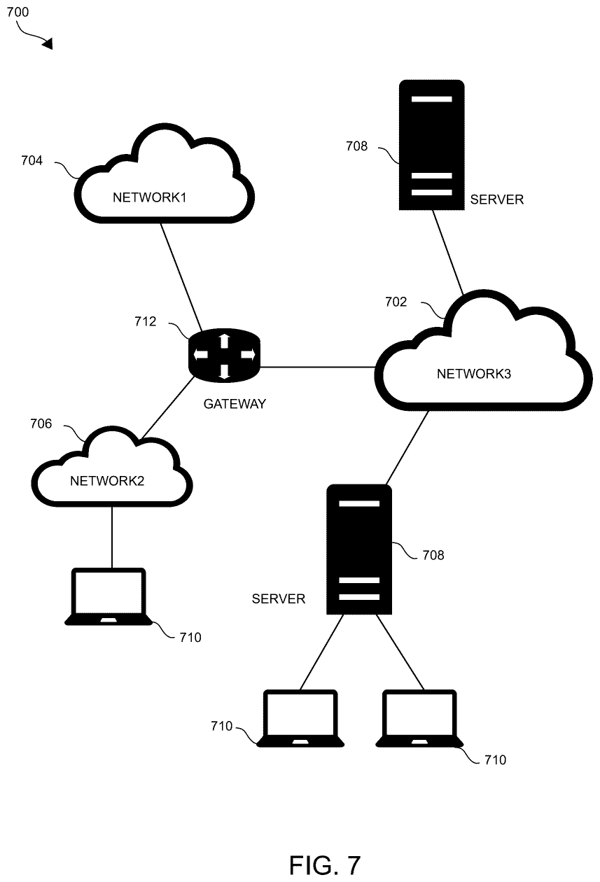

FIG. 7 illustrates a network architecture 700, in accordance with one embodiment. As shown, a plurality of networks, Network1 704, Network2 706, and Network3 702, are provided. In the context of the present network architecture, the networks, Network1 704, Network2 706, and Network3 702 may each take any form including, but not limited to a local area network (LAN), a wireless network, a wide area network (WAN) such as the Internet, peer-to-peer network, etc. Additionally, such networks may include a RFID communication between Client 710 and another device (e.g., wearable, cloud, tag, etc.). Further, such networks may include any peer to peer (P2P) or device to device communication. In the context of the present description, a client may include an end user computer, a desktop computer, a laptop computer, a mobile device, a mobile phone, a tablet, a personal digital assistant (PDA), a television, a set-top box, etc.

Coupled to the Network3 702 are one or more Server 708 which are capable of communicating over the Network3 702, as well as any other applicable network (e.g., Network1 704, Network2 706, etc.). Also coupled to Network2 706 and Network3 702 (or any other applicable network) and the Server 708 is a plurality of Client 710. Such a Server 708 and/or Client 710 may each include a desktop computer, lap-top computer, hand-held computer, mobile phone, portable device, personal digital assistant (PDA), peripheral (e.g., printer, etc.), any component of a computer, and/or any other type of logic. In order to facilitate communication among Network1 704, Network2 706, Network3 702, and/or any other network, at least one Gateway 712 is optionally coupled therebetween. In the context of the present description, cloud refers to one or more servers, services, and/or resources which are located remotely.

FIG. 8 illustrates an exemplary system 800 in which the various architecture and/or functionality of the previous embodiment and/or subsequent embodiments may be implemented. As shown, the exemplary system 800 is provided including at least one host central processor 810 which is connected to a communication bus 812. The system also includes a main memory 808. Control logic (software) and data are stored in the main memory 808 which may take the form of random access memory (RAM). The communication bus 812 may also be a system interface. The system interface may further be coupled to one or more instances of a network interface 814 and one or more instances of a co-processor and/or an accelerator 816 that me be used to perform some special function operations.

The system also includes a graphics processor 802 and a display 806, e.g., a computer monitor. In one embodiment, the graphics processor 802 may include a plurality of shader modules, a rasterization module, etc. Each of the foregoing modules may even be situated on a single semiconductor platform to form a graphics processing unit (GPU).

The system may also include a secondary storage 804. The secondary storage 804 includes, for example, at least one of a non-volatile memory (e.g., flash memory, magneto-resistive memory, ferroelectric memory, etc.), a hard disk drive, and a removable storage drive, representing a floppy disk drive, a magnetic tape drive, a compact disk drive, a USB drive, etc. The removable storage drive reads from and/or writes to a removable storage unit in a well-known manner.

Computer programs, or computer control logic algorithms, may be stored in the main memory 808 and/or the secondary storage 804. Such computer programs, when executed, enable the system to perform various functions. The main memory 808, the secondary storage 804 and/or any other storage are possible examples of computer-readable media.

In one embodiment, the architecture and/or functionality of the various previous figures may be implemented in the context of the host central processor 810, graphics processor 802, an integrated circuit (not shown) that is capable of at least a portion of the capabilities of both the host central processor 810 and the graphics processor 802, a chipset (i.e. a group of integrated circuits designed to work and sold as a unit for performing related functions, etc.), and/or any other integrated circuit for that matter.

Additionally, the architecture and/or functionality of the various previous figures may be implemented in the context of a general computer system, a circuit board system, a game console system dedicated for entertainment purposes, an application-specific system, and/or any other desired system. For example, the system may take the form of a desktop computer, a laptop computer, a server computer, and/or any other type of logic. Still yet, the system may take the form of various other devices including, but not limited to, a personal digital assistant (PDA) device, a mobile device, a tablet device, a television, etc. In the context of the present description, a mobile device may include any portable computing device, including but not limited to, a laptop computer, a tablet computer, a desktop computer, a mobile phone, a media player, a camera, a television, and/or any other portable computing device.

Further, while not shown, the system may be coupled to a network (e.g., a telecommunications network, local area network (LAN), wireless network, wide area network (WAN) such as the internet, peer-to-peer network, cable network, etc.) for communication purposes. As an example, any of the networks, Network1 704, Network2 706, and/or Network3 702 may be used for such coupling.

Of course, the various embodiments set forth herein may be implemented utilizing hardware, software, or any desired combination thereof. For that matter, any type of logic may be utilized which is capable of implementing the various functionality set forth herein.

While specific embodiments of the invention have been described, it is understood that the present invention is not intended to be limited only to such embodiments. Additionally, the scope of the preferred embodiment should be defined by the following claims and their equivalents. Moreover, any combination of the above-described elements in all possible variations thereof is encompassed unless otherwise indicated herein or otherwise clearly contradicted by context. Further, the use of the terms “a” and “an” and “the” and similar referents in the context of describing the subject matter (particularly in the context of the claims) are to be construed to cover both the singular and the plural, unless otherwise indicated herein or clearly contradicted by context. No language in the specification should be construed as indicating any non-claimed element as essential to the practice of the invention as claimed.

More particularly the deployment scenarios of the foregoing can be different based upon the particular computer processing challenge to be undertaken. For example, some computer processing problems are facilitated when the instruction prefix field is decoded in a manner that is commensurate with such a computer processing challenge. The prefix instruction and the prefix operand could be directed towards several different capabilities, such as for example using a condition (e.g. such as a condition code generated based on processor flags) to modify a succeeding instruction into a conditional execution instruction; or the prefix instruction and prefix operand could be used to change the type of operands processed in/by the succeeding instruction such as converting a word rotation instruction into a longword rotation instruction or a byte rotation instruction by merely providing a TYPE operand; similar functionality and method can be provided for modifying the functionality of an existing instruction ever so slightly or providing a hint to an instruction, especially the ones that use caches or other storage, or branch instructions including conditional branch instructions, in order to affect their mode of operation to reduce latency.

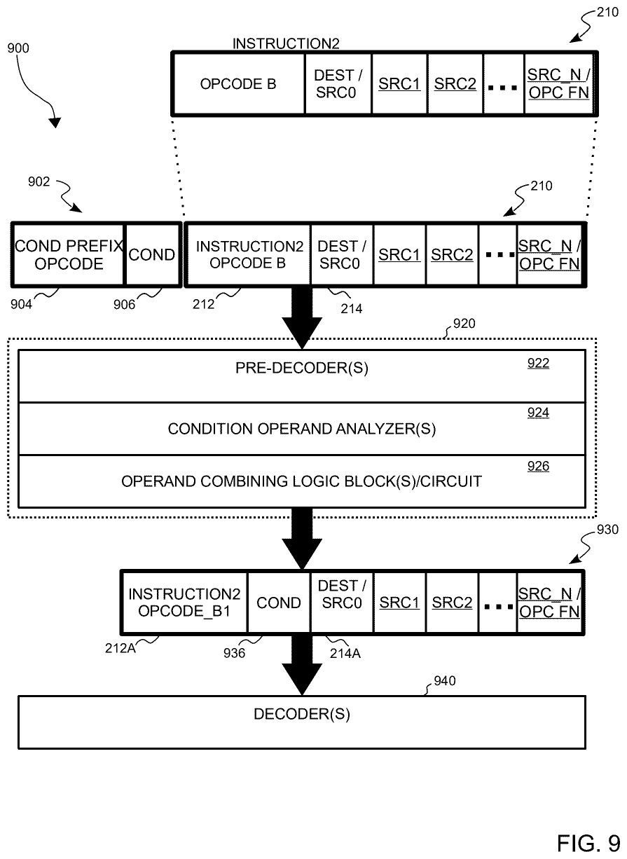

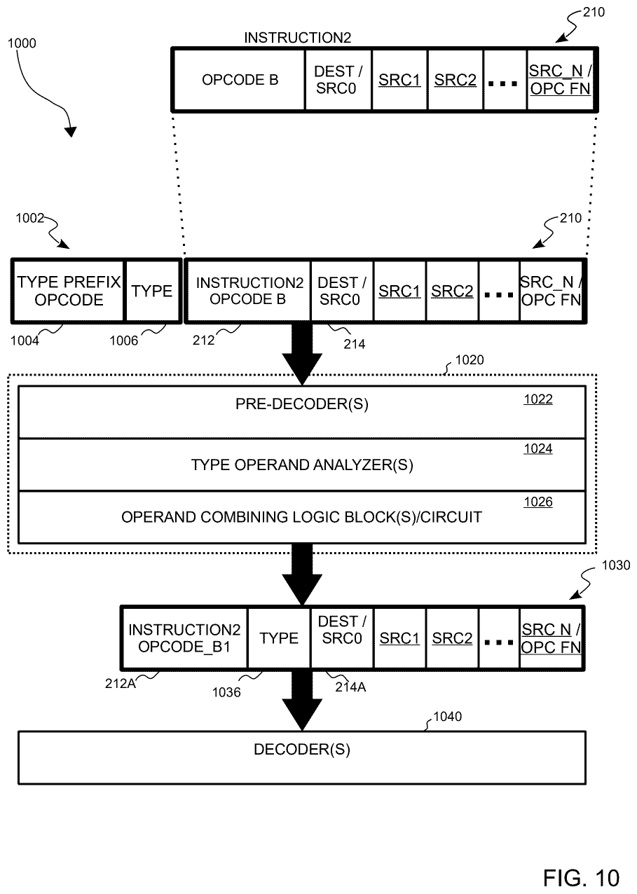

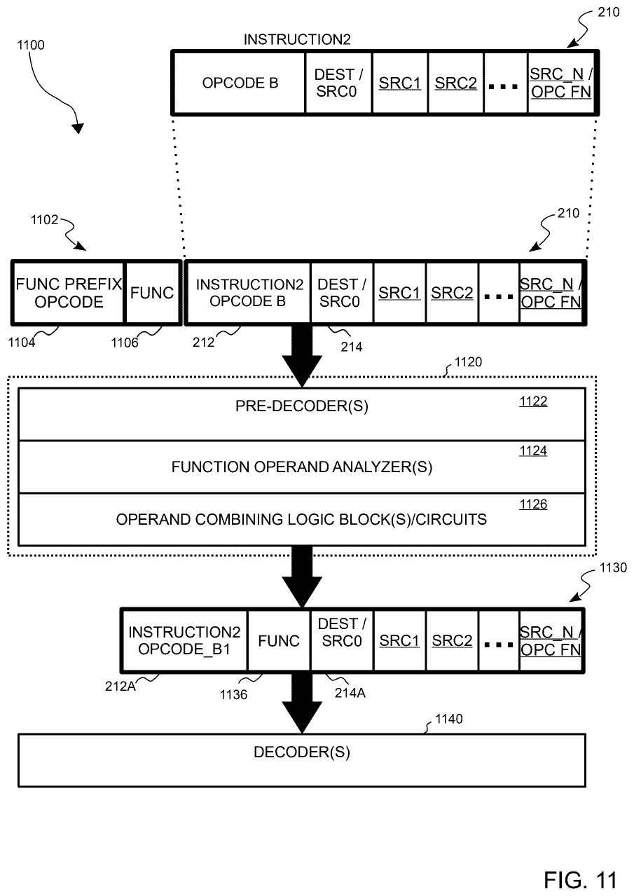

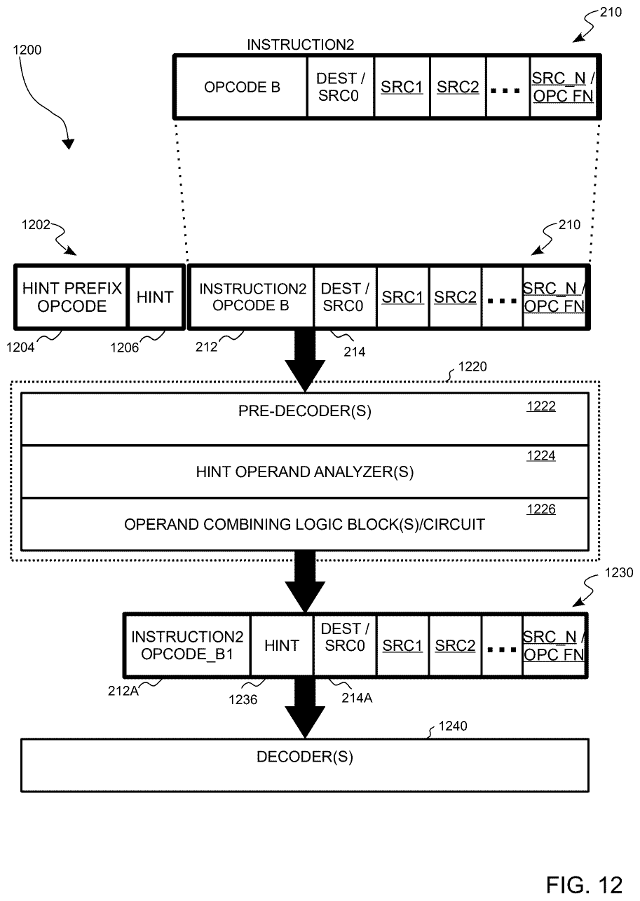

The basic structure of the mechanisms and techniques disclosed heretofore in the context of a computing machine comprise a pre-decoder that identifies an operand prefix instruction and a consuming instruction; an operand analyzer that performs analysis and accepts or rejects a prefix operand for conjunction with the consuming instruction; and an operand combining logic block that combines the prefix operand with the consuming instruction to create a combined instruction for execution. Examples of the foregoing are shown and described as pertaining to FIG. 9, FIG. 10, FIG. 11 and FIG. 12.

FIG. 9 illustrates an instruction condition operand prefixing combinator and decoder 900, in accordance with one possible embodiment. Optionally, the instruction condition operand prefixing combinator and decoder 900 may be implemented in the context of any of the foregoing figures.

In one embodiment shown in FIG. 9, an instruction such as, for example, instruction 210 (INSTRUCTION2) from FIG. 2, may be used in a computing system. Instruction 210 comprises an instruction opcode 212 (e.g. OPCODE B), an operand 214 serving as a destination operand (e.g. DEST) to store a result, and operand 214 may optionally be also a source operand (e.g. SRC0); optionally, other operands of instruction 210 may comprise operands such as for example, SRC1, SRC2, and so on. Instruction 210 may be used stand alone, where it is expected to perform an operation as defined by the instruction architecture, or it may be used in conjunction with a prefix instruction which modifies the functionality of instruction 210 in well-defined ways as in the embodiment shown in FIG. 9.

In the embodiment of FIG. 9, in the instruction condition operand prefixing combinator and decoder 900, a first instruction 902 (i.e., condition operand prefix instruction) may comprise a prefix opcode 904 (for e.g., operand prefix opcode PFXC) and a prefix operand 906 (condition operand COND) which may define a condition code (CC) or a condition flag (CF), as may be defined in an instruction set architecture. A non-exhaustive list of example condition codes may include ZERO, GREATER_THAN, LESS_THAN, ABOVE_OR_EQUAL, BELOW, NEGATIVE, NOT_ZERO, NOT_LESS_THAN, etc., where COND may be one of the condition codes and becomes true when that condition becomes true during execution. A non-exhaustive exemplar list of condition flags may include ZERO_FLAG, CARRY_FLAG, OVERFLOW, SIGN, DENORMAL, BRANCH_TAKEN, INTERRUPT_TAKEN, FLOATING_POINT_ERROR, FLOATING_POINT_GREATER_THAN, etc., where COND may represent one of the condition flags and becomes true upon assertion of that condition flag. The second instruction 210 (e.g. INSTRUCTION 2) may comprise an instruction opcode 212 (for e.g., OPCODE B, an opcode for operation B), at least one operand 214 (for e.g., an operand X which may be a destination operand (e.g. DEST) and/or a source operand (e.g. SRC0)), and optionally, zero or more operands such as SRC1, SRC2, etc.; the second instruction 210 may further comprise a field which may be an opcode function (e.g., OPC FN) or an operand SRC_N, etc. The first instruction and the second instruction are fed to an instruction operand prefixing combinator 920 comprising a set of one or more pre-decoder(s) that includes at least one pre-decoder 922, one or more condition analyzer(s) comprising at least one condition analyzer 924 (e.g., condition analyzer logic circuit, when implemented in hardware; or condition analyzer logic block/subroutine when implemented in software, or in microcode), and one or more condition operand combining logic block(s) comprising at least one condition combining logic block 926. These logic block(s) may be implemented as logic circuits in hardware, or as procedures, functions or subroutines in microcode in/on hardware, or as procedures, functions or subroutines in software when used in a binary translator or a simulator program. The pre-decoder(s) such as the at least one pre-decoder 922 may be implemented in hardware as circuits, or as subroutine(s) in microcode, or may be implemented in software using functions, subroutines or procedures when used in a binary translation or simulator program.

The at least one pre-decoder 922 evaluates the first instruction 902 and the second instruction 210, and wherein the first instruction 902 is evaluated to determine whether it is an operand prefix instruction and what kind of operand prefixing instruction; and wherein the second instruction 210 is evaluated to determine whether it is an operand consuming instruction that can receive a prefix operand such as the condition prefix operand 906 (condition operand COND). Upon an affirmative confirmation from an evaluation of the validity of one or more operand prefixing opcodes and/or consumption criteria of the prefix operand, the at least one condition analyzer 924 evaluates the condition operand COND (condition prefix operand 906) and the instruction 210 to determine if they form a valid combination for execution as a conditional instruction of the form “if COND is TRUE, execute INSTRUCTION2; else skip execution of INSTRUCTION2” (i.e. if (COND) INSTRUCTION2; else instruction alternate to INSTRUCTION2;) (in a typical embodiment, instruction alternate to INSTRUCTION2 is the instruction that comes immediately after INSTRUCTION2), (however, other schemes are also possible, where a different unrelated instruction may be selected for execution); and if a valid combination for execution is determined then a control signal (e.g., an operand acceptance control signal) may be asserted by the at least one condition analyzer 924. In some cases, while the at least one pre-decoder 922 determines the operand prefix instruction 902 to be a condition operand prefix instruction, the condition in instruction 902 may not be legally usable with instruction 210 (INSTRUCTION2 with OPCODE B) within the semantics for execution defined by the instruction set architecture of an embodiment. For e.g., some architecture may not support “if (COND) then NOP; else skip NOP”; or in another example “if (COND) then BRANCH_ON_NOCOND) else skip BRANCH_ON_NOCOND”, which leads to a degenerate case may not be supported. This would occur if a condition prefix operand COND were used along with an instruction BRANCH_ON_NOCOND (e.g. if (ZERO) then BRANCH_ON_NOZERO). Another example of a degenerate case may be “if (COND) then BRANCH_ON COND, else skip”. While degenerate cases may not be harmful, they may or may not be supported by a computing system. The condition analyzer 924 (e.g. condition analyzer logic circuit, or condition analyzer logic block, or condition analyzer subroutine/function/procedure) may look up a table of barred or unacceptable instructions/unacceptable opcodes (or other portions of an instruction)/unacceptable instruction combinations, etc., to determine invalid instruction combinations; or condition analyzer 924 may look up a table of acceptable instructions or acceptable opcodes (or other portions of an instruction), or acceptable instruction combinations, etc., to determine valid instruction combinations. A valid instruction combination may be signaled by asserting a control signal such as the operand acceptance control signal (not shown).

If the control signal (e.g., the operand acceptance control signal) is asserted to indicate a valid instruction combination then the at least one condition combining logic block 926 receives the second instruction 210 and the condition COND in prefix operand 906 and combines them to create a combined instruction 930 (in a condition combining operation). The combined instruction 930 has a COND operand in a field 936 along with the rest of the fields of instruction 210 (consuming instruction). In some embodiments, a condition code or condition flag in the second instruction 210 (consuming instruction) may be replaced by the condition prefix operand (e.g., the condition prefix operand 906). In some embodiments, in response to the acceptance of the condition operand 906, the combined instruction gains an additional operand 936 (condition COND) over the second instruction. Combined instruction 930 comprises instruction opcode 212A and operand (OPD X) 214A inherited from the consuming instruction such as the second instruction 210 and rest of the operands of instruction 210.

The combined instruction 930 may be stored in a buffer or a latch stage or may be directly provided as an input to one or more decoders (for e.g., instruction decoders) that include at least one decoder 940 for further decoding, processing, and further execution. In some embodiments the combined instruction may be scheduled as if it were the original second instruction, and in such embodiments the combined instruction may be retired as if it is the original second instruction. In some other embodiments the combined instruction may be executed in lieu of the first and second instructions. Since an operand prefix instruction (e.g., condition operand prefix instruction) is best treated similar to a prefix, it is best to not independently execute the prefix instruction.

In some other embodiments, the combined instruction and the first instruction, both may be presented to the one or more decoders (such as for e.g., the at least one decoder 940). The one or more decoders (such as the at least one decoder 940) may treat the first instruction (e.g., first instruction 902 (which is an operand prefix instruction)) as equivalent of a NOP (no operation) instruction since the prefix operand (e.g. condition prefix operand 906 i.e., prefix operand COND) is combined to form the combined instruction (e.g., combined instruction 930). In some embodiments both the first instruction (the operand prefix instruction) which is transformed or relegated as a NOP instruction, and the combined instruction may be executed and then retired.

In some other embodiments, the first instruction (e.g., operand prefix instruction) transformed to or relegated as a NOP instruction after the prefix combining operation, may be suppressed and/or discarded without further scheduling during decoding or farther on. In some other embodiments, the first instruction is not scheduled for execution, and only the “second” instruction or the combined instruction may be scheduled for execution. Consequently, the first instruction is not executed after creation of the combined instruction. This may save at least one execution clock cycle.

While it is conceivable to execute the condition prefix instruction as a predicate instruction that sets a flag/predicate upon the truth assertion of the condition COND, and the second/following instruction as a predicated instruction to be executed upon the truth assertion of the predicate without fusing the two instructions, it may not be a preferred method of implementing the best mode since that may consume more than one execution clock cycle, although this disclosure teaches this mode also.

In any embodiments where both the first instruction (possibly transformed to become equivalent of a NOP instruction) and the combined instruction (primarily derived from the second instruction) are decoded and scheduled, any interrupts and exceptions may be handled as known in the art, whereas in other embodiments interrupt and exceptions are handled in a manner that is consistent with the embodiments.

In some embodiments where the first instruction transforms to become equivalent of a NOP instruction, and is suppressed or discarded during or after decode, the interrupts and exceptions may use the second instruction (and/or the combined instruction derived/obtained from the second instruction) as the marker instruction; and any concurrent interrupts or exceptions may be recorded as if they occurred either before or after the execution of the combined instruction depending on the nature of the interrupt or exception. The combined instruction (e.g. combined instruction 930) itself may cause an exception including traps, aborts, faults, failures, etc., to occur because of execution or an execution attempt.

FIG. 10 illustrates an instruction type operand prefixing combinator and decoder 1000, in accordance with one possible embodiment. Optionally, the instruction type operand prefixing combinator and decoder 1000 may be implemented in the context of any of the foregoing figures.

In one embodiment shown in FIG. 10, an instruction such as, for example, instruction 210 (INSTRUCTION2) from FIG. 2, may be used in a computing system. Instruction 210 comprises an instruction opcode 212 (e.g. OPCODE B), an operand 214 serving as a destination operand (e.g. DEST) to store a result, and operand 214 may optionally be also a source operand (e.g. SRC0); optionally, other operands of instruction 210 may comprise operands such as for example, SRC1, SRC2, and so on. Instruction 210 may be used stand alone, where it is expected to perform an operation as defined by the instruction architecture, or it may be used in conjunction with a prefix instruction which modifies the functionality of instruction 210 in well-defined ways as in the embodiment shown in FIG. 10.

In the embodiment shown in FIG. 10, instruction 210 (e.g. INSTRUCTION2) used in the computing system comprises an instruction opcode 212 (such as OPCODE B), an operand 214 serving as a destination operand (e.g. DEST) to store a result, and operand 214 may optionally be also a source operand (e.g. SRC0); optionally, other operands of instruction 210 may comprise operands such as for example, SRC1, SRC2, and so on. Instruction 210 may be used stand alone, where it is expected to perform an operation as defined by the instruction architecture; or instruction 210 may be used in conjunction with a prefix instruction such as instruction 202 which modifies the functionality of instruction 210 in well-defined ways as shown in the embodiment shown in FIG. 2. In the context of the embodiment of FIG. 2, the word operand may mean the name of a register or a memory location, for example. However, the word operand could also mean something else in the context of other embodiments.

In the embodiment of FIG. 10, in the instruction type operand prefixing combinator and decoder 1000, a first instruction 1002 (i.e., type operand prefix instruction) may comprise a prefix opcode 1004 (for e.g., operand prefix opcode PFXT) and a prefix operand 1006 (type operand TYPE) which may be used to define or redefine the TYPE of an object or value, in accordance with an instruction set architecture. A non-exhaustive list of types, for example, may include scalar types like bit, nibble, byte, word, integer, longword, short integer, single-precision floating-point, half-precision floating point, packed array of bytes, packed array of shorts, ordered pair of bytes, ordered pair of shorts, ordered pair of half-precision floating point values, triads (e.g., group of 3 numbers) of various scalar types, quads (e.g., group of 4 numbers) of various scalar types, vectors of various types, matrix types, etc. The first instruction works in conjunction with a second instruction such as instruction 210.

The second instruction 210 (e.g. INSTRUCTION 2) may comprise an instruction opcode 212 (for e.g., OPCODE B, an opcode for operation B), at least one operand 214 (for e.g., an operand X which may be a destination operand (e.g. DEST) and/or a source operand (e.g. SRC0)), and optionally, zero or more operands such as SRC1, SRC2, etc.; the second instruction 210 may further comprise a field which may be an opcode function (e.g., OPC FN) or an operand SRC_N, etc. The first instruction and the second instruction are fed to an instruction operand prefixing combinator 1020 comprising a set of one or more pre-decoder(s) that includes at least one pre-decoder 1022, one or more type analyzer(s) comprising at least one type analyzer 1024 (e.g., type analyzer logic circuit, when implemented in hardware; or type analyzer logic block/subroutine when implemented in software, or in microcode), and one or more type operand combining logic block(s) comprising at least one type combining logic block 1026. These logic block(s) may be implemented as logic circuits in hardware, or as procedures, functions or subroutine(s) in microcode in/on hardware, or using procedures, functions or subroutines in software when used in a binary translator or a simulator program. The pre-decoder(s) such as the at least one pre-decoder 1022 may be implemented in hardware as circuits, or as a subroutine(s) in microcode, or may be implemented in software as using functions, subroutines or procedures when used in a binary translation or simulator program.

The at least one pre-decoder 1022 evaluates the first instruction 1002 and the second instruction 210, and wherein the first instruction 1002 is evaluated to determine whether it is an operand prefix instruction and what kind of operand prefixing instruction; and wherein the second instruction 210 is evaluated to determine whether it is an operand consuming instruction that can receive a prefix operand such as the type prefix operand 1006 (type operand TYPE). Upon an affirmative confirmation from an evaluation of the validity of one or more operand prefixing opcodes and/or consumption criteria of the prefix operand, the at least one type analyzer 1024 evaluates the type operand TYPE (type prefix operand 1006) and the instruction 210 to determine if they form a valid combination for execution. A valid instruction combination may be signaled by asserting a control signal such as the operand acceptance control signal.

The assertion of the operand acceptance control signal causes the type combining logic block 1026 (e.g. in hardware it may be implemented as type combining logic circuit, or in microcode as a type combining subroutine; and in software it may be implemented using functions, procedures or subroutines) to include the prefix TYPE information into a new instruction 1030 comprising the TYPE and instruction 210. The combined instruction 1030 has a TYPE field 1036 along with the rest of the fields of instruction 210 (consuming instruction). In some embodiments, an existing type field in instruction 210 may be replaced or redefined with the new TYPE value. In some consuming instruction 210 that had value(s) or operand(s) whose type(s) were implicitly defined or known, one or more of those type(s) may be redefined; or the type of the result (or destination operand) and the manner of its computation may become redefined (for e.g., addition of two floating point numbers may be treated as if it were the addition of two half-precision floating point numbers if TYPE is indicated as HALF_PRECISION, even if the default behavior devoid of TYPE was for the addition of two single-precision floating point numbers), and the combined instruction is executed accordingly as per the redefinition. Obviously, it is expected that the processor executing the instruction supports such a redefinition capability for such a mechanism to succeed. This capability is particularly useful in extending an instruction set architecture using existing instructions as much as possible in an ever shrinking instruction set space available.

The combined instruction may be stored in a buffer or a latch stage or may be directly provided as an input to one or more decoders (for e.g., instruction decoders) that include at least one decoder 1040 for further decoding, processing, and further execution. In some embodiments the combined instruction may be scheduled as if it were the original second instruction, and in such embodiments the combined instruction may be retired as if it is the original second instruction. In some other embodiments the combined instruction may be executed in lieu of the first and second instructions. Since a type operand prefix instruction is best treated as a prefix, it is best to not independently execute the prefix instruction. In some other embodiments if the type prefix instruction is also presented for execution it is converted into a NOP, and the methods heretofore disclosed and described may be used, with special emphasis on the techniques disclosed in embodiment 200 and embodiment 900.

FIG. 11 illustrates an instruction function operand prefixing combinator and decoder 1100, in accordance with one possible embodiment. Optionally, the instruction function operand prefixing combinator and decoder 1100 may be implemented in the context of any of the foregoing figures.

In the embodiment of FIG. 11, in the instruction function operand prefixing combinator and decoder 1100, a first instruction 1102 (i.e., function operand prefixing instruction) may comprise a prefix opcode 1104 (for e.g., operand prefix opcode PFXF) and a prefix operand 1106 (function operand FUNC) which may be used to define or redefine the operation or functionality of a second instruction, in accordance with an instruction set architecture. The first instruction 1102 works in conjunction with a second instruction such as the second instruction 210 and redefines operation of the instruction 210 (the second instruction).

The second instruction 210 (e.g. INSTRUCTION 2) may comprise an instruction opcode 212 (for e.g., OPCODE B, an opcode for operation B), at least one operand 214 (for e.g., an operand X which may be a destination operand (e.g. DEST) and/or a source operand (e.g. SRC0)), and optionally, zero or more operands such as SRC1, SRC2, etc.; the second instruction 210 may further comprise a field which may be an opcode function (e.g., OPC FN) or an operand SRC_N, etc. The first instruction 1102 and the second instruction 210 are fed to an instruction operand prefixing combinator 1120 comprising a set of one or more pre-decoder(s) that includes at least one pre-decoder 1122, one or more function operand analyzer(s) comprising at least one function operand analyzer 1124 (e.g., function operand analyzer logic circuit, when implemented in hardware; or function operand analyzer logic block/subroutine when implemented in software, or in microcode), and one or more function operand combining logic block(s) comprising at least one function operand combining logic block 1126 (in short for e.g., function combining logic block). These logic block(s) may be implemented as logic circuits (e.g., function combining circuit(s)) in hardware, or as procedures, functions or subroutine(s) in microcode running in/on hardware, or using procedures, functions or subroutines in software when used in a binary translator or a simulator program. The pre-decoder(s) such as the at least one pre-decoder 1122 may be implemented in hardware as circuits, or as a subroutine(s) in microcode, or may be implemented in software as using functions, subroutines or procedures when used in a binary translation or simulator program.

The at least one pre-decoder 1122 evaluates the first instruction 1102 and the second instruction 210, and wherein the first instruction 1102 is evaluated to determine whether it is an operand prefix instruction and what kind of operand prefixing instruction; and wherein the second instruction 210 is evaluated to determine whether it is an operand consuming instruction that can receive a prefix operand such as the function prefix operand 1106 (function operand FUNC). Upon an affirmative confirmation from an evaluation of the validity of one or more operand prefixing opcodes and/or consumption criteria of the prefix operand, the at least one function operand analyzer 1124 evaluates the function operand FUNC (function prefix operand 1106) and the instruction 210 to determine if they form a valid combination for execution. A valid instruction combination may be signaled by asserting a control signal such as the operand acceptance control signal.

The assertion of the operand acceptance control signal causes the function combining logic block 1126 (e.g. in hardware it may be implemented as a function combining logic circuit, or in microcode as a function combining subroutine; and in software it may be implemented using functions, procedures or subroutines) to include the prefix FUNC information (code or opcode or field value or function code as the case may be) into a new combined instruction 1130 comprising the FUNC and instruction 210. The combined instruction 1130 has a FUNC field 1136 along with the rest of the fields of instruction 210 (consuming instruction), namely opcode 212A, destination operand 214A (DEST) (which may optionally also be a source operand SRC0) and other operands such SRC1, SRC2, etc. In some embodiments, an existing function field in instruction 210 may be replaced or redefined with the new FUNC value/code. In some consuming instruction 210 that had a default functionality that was implicitly defined or known, the default functionality could be redefined due to the combination in the combined instruction; Obviously, it is expected that the processor executing the instruction supports such a redefinition capability for the combined instruction execution for such a mechanism to succeed. This capability is particularly useful in extending an instruction set architecture using existing instructions as much as possible in an ever shrinking instruction set space available.

The combined instruction 1130 may be stored in a buffer or a latch stage or may be directly provided as an input to one or more decoders (for e.g., instruction decoders) that include at least one decoder 1140 for further decoding, processing, and further execution.

In the embodiment of FIG. 11, Instruction 210 may have a default functionality when executed independently. The functionality of instruction 210 when executed in conjunction with prefix instruction 1102, as the combined instruction 1130 could be different from the default functionality (when instruction 210 is executed without the function operand prefix instruction 1102) in some aspect. For e.g., in an image processor, an instruction that by default computes a color transformation based on an RGB color scheme (RED, GREEN, BLUE color scheme) could be modified using a function prefix instruction to work as a different instruction that computes a similar color transformation based on an HSL color scheme (Hue, Saturation, Lightness color scheme) using a FUNC that is set as a code for HSL; and in yet another case a function prefix instruction with FUNC code set for CMY color space may be used to perform a similar transformation for colors given in the CMY color space (Cyan, Magenta, Yellow). This capability is particularly useful in extending an instruction set architecture using existing instructions as much as possible in an ever shrinking instruction set space available. For e.g., when a new color space is introduced, a set of instructions can all be transformed into similar new instructions by simply adding a field code (or function code or function-opcode) for a new function entry for the function operand FUNC in a function prefix instruction.

In some embodiments the combined instruction may be scheduled as if it were the original second instruction, and in such embodiments the combined instruction may be retired as if it is the original second instruction. In some other embodiments the combined instruction may be executed in lieu of the first and second instructions. Since a function operand prefix instruction is best when treated as a prefix, it is best to not independently execute the prefix instruction. In some other embodiments if the function prefix instruction is also presented for execution it is converted into a NOP, and the methods heretofore disclosed and described may be used, with special emphasis on the techniques disclosed in embodiment 200 and embodiment 900.

FIG. 12 illustrates an instruction hint operand prefixing combinator and decoder 1200, in accordance with one possible embodiment. Optionally, the instruction hint operand prefixing combinator and decoder 1200 may be implemented in the context of any of the foregoing figures.

In the embodiment of FIG. 12, in the instruction hint operand prefixing combinator and decoder 1200, a first instruction 1202 (i.e., hint operand prefixing instruction) may comprise a prefix opcode 1204 (for e.g., operand prefix opcode PFXH) and a prefix operand 1206 (hint operand HINT) which may be used to define or redefine the mode/method of operation of a second instruction, in accordance with an instruction set architecture. The first instruction 1202 works in conjunction with a second instruction such as the second instruction 210 and redefines the mode/method of operation of the instruction 210 (the second instruction).

The second instruction 210 (e.g. INSTRUCTION 2) may comprise an instruction opcode 212 (for e.g., OPCODE B, an opcode for operation B), at least one operand 214 (for e.g., an operand X which may be a destination operand (e.g. DEST) and/or a source operand (e.g. SRC0)), and optionally, zero or more operands such as SRC1, SRC2, etc.; the second instruction 210 may further comprise a field which may be an opcode function (e.g., OPC FN) or an operand SRC_N, etc. The first instruction 1202 and the second instruction 210 are fed to an instruction operand prefixing combinator 1220 comprising a set of one or more pre-decoder(s) that includes at least one pre-decoder 1222, one or more hint operand analyzer(s) (i.e. hint analyzer(s)) comprising at least one hint operand analyzer 1224 (e.g., hint analyzer logic circuit, when implemented in hardware; or hint analyzer subroutine/function/procedure when implemented in software, or in microcode), and one or more hint operand combining logic block(s) comprising at least one hint operand combining logic block 1226 (in short for e.g., hint combining logic block). These logic block(s) may be implemented as logic circuits (e.g., hint combining circuit(s)) in hardware, or as procedures, functions or subroutine(s) in microcode running in/on hardware, or using procedures, functions or subroutines in software when used in a binary translator or a simulator program. The pre-decoder(s) such as the at least one pre-decoder 1222 may be implemented in hardware as circuit(s), or as subroutine(s) in microcode, or may be implemented in software as using functions, subroutines or procedures when used in a binary translation or simulator program.

The at least one pre-decoder 1222 evaluates the first instruction 1202 and the second instruction 210, and wherein the first instruction 1202 is evaluated to determine whether it is an operand prefix instruction and what kind of operand prefixing instruction; and wherein the second instruction 210 is evaluated to determine whether it is an operand consuming instruction that can receive a prefix operand such as the hint prefix operand 1206 (e.g., hint operand HINT). Upon an affirmative confirmation from an evaluation of the validity of one or more operand prefixing opcodes and/or consumption criteria of the prefix operand, the at least one hint operand analyzer 1224 evaluates the hint operand HINT (hint prefix operand 1206) and the instruction 210 to determine if they form a valid combination for execution. A valid instruction combination may be signaled by asserting a control signal such as the operand acceptance control signal.

The assertion of the operand acceptance control signal causes the hint operand combining logic block 1226 (e.g. in hardware it may be implemented as a hint operand combining logic circuit, or in microcode as a hint operand combining subroutine; and in software it may be implemented using functions, procedures or subroutines) to include the prefix HINT information (code or opcode or field value or function code as the case may be) into a new combined instruction 1230 comprising the HINT and instruction 210. The combined instruction 1230 has a HINT field 1236 along with the rest of the fields of instruction 210 (consuming instruction), namely opcode 212A, destination operand 214A (DEST) (which may optionally also be a source operand SRC0) and other operands such SRC1, SRC2, etc. In some embodiments, an existing function field in instruction 210 may be replaced or redefined with the new HINT value/code. In some consuming instruction 210 that had a default mode of operation that was implicitly defined or known, the default mode could be redefined due to the combination in the combined instruction. Hints may be used to speed up operations such as conditional branches to provide a hint about the direction of a branch at a particular iteration with a high probability; hints need not be used, and hints are not mandates that can change the functionality of an instruction except possibly having some side effects which may not be architecturally disallowed. Other examples may include hints that may be used as prefixes for load followed by stores to affect the cache line prefetching or sharing considerations. Obviously, it is expected that the processor executing the instruction supports such a redefinition capability for the combined instruction execution for such a mechanism to succeed. This capability is particularly useful in extending an instruction set architecture using existing instructions as much as possible in an ever shrinking instruction set space available.

The combined instruction may be stored in a buffer or a latch stage or may be directly provided as an input to one or more decoders (for e.g., instruction decoders) that include at least one decoder 1240 for further decoding, processing, and further execution. In some embodiments the combined instruction may be scheduled as if it were the original second instruction, and in such embodiments the combined instruction may be retired as if it is the original second instruction. In some other embodiments the combined instruction may be executed in lieu of the first and second instructions. Since a hint operand prefix instruction is best treated as a prefix, it is best to not independently execute the prefix instruction. In some other embodiments if the hint prefix instruction is also presented for execution it is converted into a NOP, and the methods heretofore disclosed and described may be used, with special emphasis on the techniques disclosed in embodiment 200 and embodiment 900.

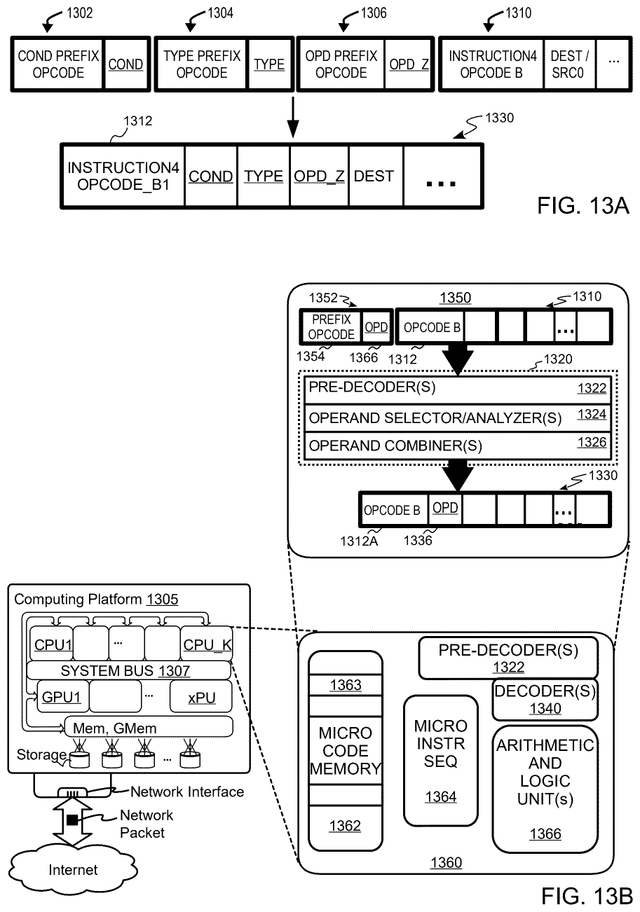

FIG. 13A illustrates a combined instruction formed by combining two or more instructions in an instruction operand prefixing combinator and decoder, in accordance with one possible embodiment. Optionally, such an instruction combination in the instruction operand prefixing combinator and decoder may be implemented in the context of any of the foregoing figures.

In the embodiment of FIG. 13A, two or more instructions comprising at least one operand prefix instruction and a consuming instruction 1310 with opcode B are combined to form a combined instruction 1330 which comprises some or all fields of the consuming instruction. In FIG. 13A, condition operand prefix instruction 1302 with condition operand COND, type operand prefix instruction 1304 with type operand TYPE and source operand prefix instruction 1306 with source operand OPD_Z are combined using pre-decoders (e.g., pre-decoder 922), operand analyzers (such as for e.g., condition operand analyzer 924), and operand combiners (such as for e.g., operand combining logic block 926) with consuming instruction 1310 into a combined instruction 1330 with opcode B1, where opcode B1 is obtained by modifying opcode B to indicate addition of additional operands. The prefix instructions may be prefixed in any order or in a specific order stipulated by an instruction architecture or hardware or microcode. Furthermore, the various operand analyzers/selectors like the operand selector 224, the condition operand analyzer 924, the type operand analyzer 1024, the function operand analyzer 1124, the hint operand analyzer 1224 may be one and the same operand analyzer/selector with all of the required capabilities in one circuit or one subroutine or one function or procedure. To handle multiple prefix instructions (or prefixes) or multiple instructions parallelly, multiple pre-decoders, multiple operand analyzers and multiple operand combiners may be used to generate a combined instruction before using one or more decoders.

FIG. 13B illustrates an instruction operand prefixing combinator and decoder implemented in microcode and hardware, in accordance with one possible embodiment. Optionally, the instruction function operand prefixing combinator and decoder 1300 may be implemented in the context of any of the foregoing figures.

In the embodiment shown in FIG. 13B, an instruction operand prefixing combinator and decoder are implemented in microcode and hardware inside a central processing unit CPU_K in a computing platform 1305 connected to the internet via network interface. Computing platform 1305 may comprise one or more processing units including specialized processing unit(s) notated as xPU, one or more Graphics processing units (e.g., GPU1), central processing unit(s) (such as for e.g., CPU1, CPU_K), etc., interconnected via a system bus 1307 Computing platform 1305 may further comprise a memory (e.g., system memory Mem), a graphics memory (e.g. Gmem), some storage, etc. Processing unit such as CPU_K may comprise a microcode memory 1362 which typically is a microcode ROM (Read Only Memory), and may also, in some embodiments, include an embedded read-write RAM (Random Access Memory) in some portion for use in patching microcode or loading some microcode. An instruction operand prefixing combinator 1320 may, in part, be implemented in a microcode block and in hardware, as a subsystem 1350 using microinstructions such as microinstruction 1363 and such, residing in microcode memory 1362. Processing unit CPU_K may further comprise a microinstruction sequencer 1364 to sequence microinstructions for execution using one or more arithmetic and logic unit(s) 1366. The decoder 1340 may typically be implemented in hardware to decode instructions prior to execution to determine one or more microinstructions or microinstruction subroutine(s) to execute as appropriate.

Instructions are received in a buffer in CPU_K and in subsystem 1350, presented to pre-decoder(s) 1322 which may be implemented in hardware or in part, as a subroutine in microcode, wherein the pre-decoders 1322 identify a prefix instruction 1352 comprising a prefix opcode 1354 and a prefix operand 1366 (OPD), and a consuming instruction 1310 comprising an opcode 1312 (OPCODE B) and zero or more operands, and provide them to one or more operand selectors/analyzers to test for a valid combination. An operand selector/analyzer 1324 may determine the scope and validity of a combination of prefix operand 1366 with consuming instruction 1310. This action may be performed in microcode with the assistance of some hardware using a microcode subroutine. The microcode subroutine implementing operand analysis/selection in operand selector/analyzer 1324 may use arithmetic and logic unit(s) (ALU) 1366 and some internal temporary registers to perform the function. Upon determining the validity in the affirmative, the prefix operand 1366 may be combined with combined instruction 1310 using operand combiner 1326 implemented as a microcode subroutine that generates a combined instruction 1330. Combined instruction 1330 may be further decoded using a decoder 1340 and/or executed. Execution may also use one or more ALUs. Other possible variations in implementations of the embodiment are also possible where a portion of the work may be done using a microinstruction sequencer using hardware units and circuits to perform functions that must be performed fast.

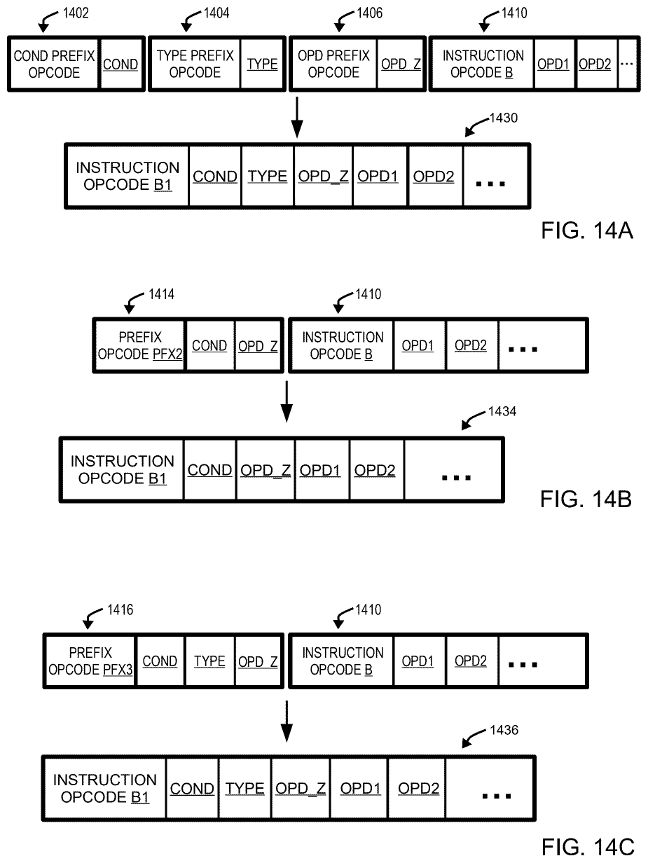

FIG. 14A illustrates an instruction combination of operand prefixing instructions and a consuming instruction resulting in a combined instruction, in accordance with one possible embodiment. Optionally, such an instruction combination may be performed by a multi-operand prefixing instruction combinator and decoder that may be implemented in the context of any of the foregoing figures. It must be understood that the process can be extended to cover more than one consuming instruction, as well.

In FIG. 14A, in one embodiment, a condition operand prefix instruction 1402 comprising a condition prefix opcode and a condition operand COND is shown. Also shown in the embodiment of FIG. 14A are a type operand prefix instruction 1404 comprising a type prefix opcode and a type operand TYPE, and a location operand prefix instruction 1406 comprising an operand prefix opcode and a location operand OPD_Z. Also shown in this embodiment is an operand consuming instruction 1410 comprising an opcode B and operands such as OPD1 and OPD2.

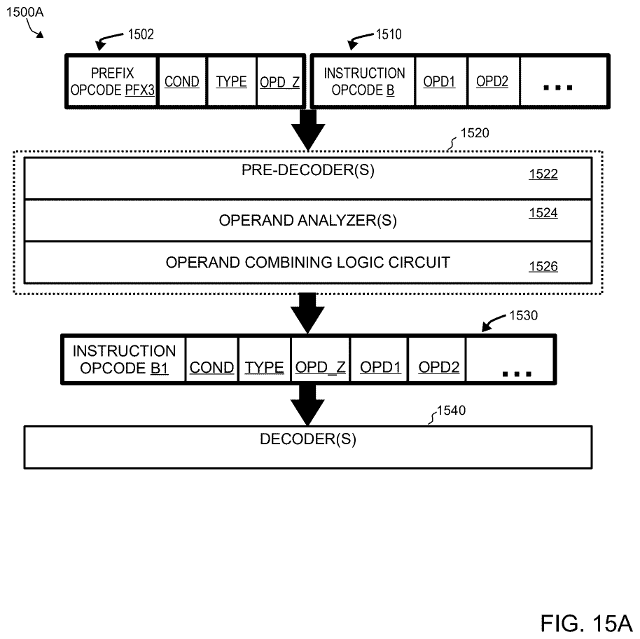

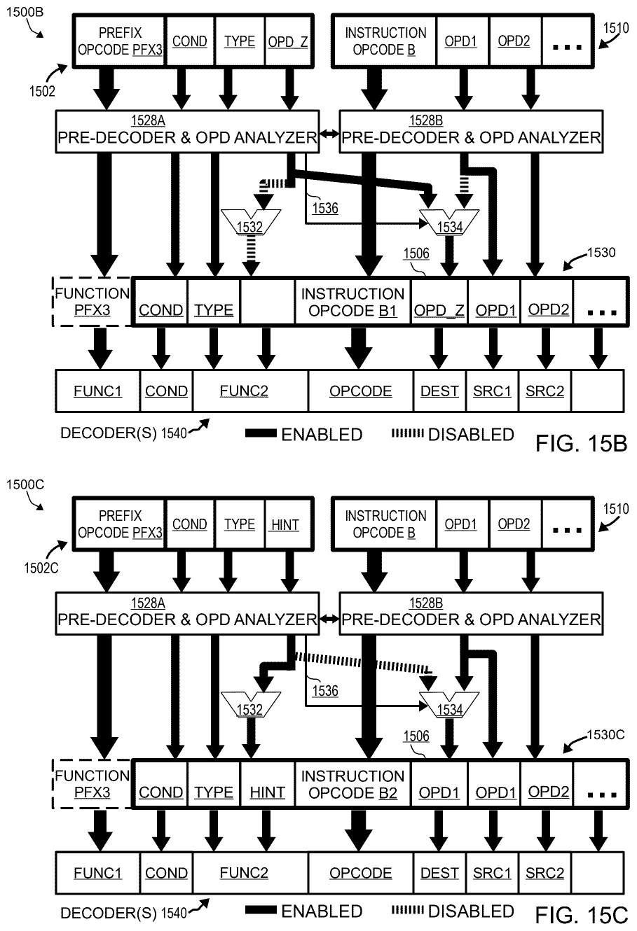

Instruction 1402, instruction 1404, instruction 1406 and instruction 1410 are combined using a multi-operand fixing instruction combinator and decoder to yield a combined instruction 1430 comprising a modified opcode B1 and operands comprising the condition COND, the type operand TYPE, the location operand OPD_Z along with operands OPD1 and OPD2 of instruction 1410, among others. Normally, the opcode for a combined instruction such as, for example, opcode B1 of combined instruction 1430 may be derived from the opcode (e.g. opcode B) of the consuming instruction (e.g. instruction 1410). In circuit, the instruction combinator comprises the pre-decoders, the operand analyzers, and the operand combining logic circuits as disclosed in any of the embodiments herein (for e.g., as in FIGS. 2, 3A, 3B, etc.). In this example embodiment, the prefix instruction 1402 is consumed by the prefix instruction 1404, and their combination is further consumed by prefix instruction 1406 and the resulting combined instruction is further consumed by the consuming instruction 1410. To consume a multi-operand prefix instruction, the instruction combinator circuit can be modified to incorporate the multiple operands of the prefixes into the combined instruction using an embodiment illustrated in FIG. 15.

The method and apparatus of combining multiple prefix operands to a consuming instruction can be simplified by defining prefix instructions with multiple operands instead of using multiple prefix instructions with single operands. This can simplify the instruction combinator and decoder design(s).

FIG. 14B illustrates an instruction combination that results in a combined instruction formed by combining a double operand prefix instruction with a consuming instruction, in accordance with one possible embodiment. Optionally, such an instruction combination may be performed by a double-operand/multi-operand prefixing instruction combinator and decoder that may be implemented in the context of any of the foregoing figures.

In the embodiment of FIG. 14B, a double operand prefix instruction 1414 comprising a prefix opcode (e.g. PFX2), a conditional operand COND and a location operand OPD_Z is combined with a consuming instruction 1410 comprising an instruction opcode B and operands such as OPD1 and OPD2, among others, which results in a combined instruction 1434 comprising an opcode B1, the conditional operand COND, the location operand OPD_Z along with the operands OPD1, OPD2, and some or all of the other operands of consuming instruction 1410. The functionality of the combined instruction would be similar to that of the consuming instruction. The multi-operand instruction combinator and decoder works in a manner similar to any of the various embodiments disclosed herein. The double operand prefix opcode such as PFX2 is pre-decoded using pre-decoder(s), the operands are analyzed using one or more operand analyzer(s), and the two prefix operands are combined with the consuming instruction using an operand combining logic circuit. Thereafter, the combined instruction is decoded using an instruction decoder and executed as per the functionality of the combined instruction which is a modified version of the consuming instruction from which the combined instruction is derived.

The method and apparatus/device/circuit in this embodiment has great utility; for example, it can be used to convert a two operand arithmetic instruction such as add A, B with a functionality given by A:=A+B, into a corresponding conditional three operand instruction, such as, Z:=(COND)?A+B, (where A, B and Z are location operands such as register(s) or memory location(s)), just by using a double operand prefix instruction. Furthermore, if the condition used is COND=‘ALWAYS’, the combined instruction reduces into a three operand instruction e.g., Z:=A+B, in this case. The overall length of the combined instruction as seen by the decoder (instruction decoder) may be equivalent to the length of the prefix instruction and the consuming instruction put together, or it may be smaller. For e.g., a double operand prefix instruction 1414 of 16-bits can be combined with a two operand arithmetic instruction of 16 bits to yield a conditional three operand arithmetic instruction of 32 bits or smaller. This may allow the decoder(s) to be simplified while allowing the decoder(s) to be built to decode a ‘compressed’ or smaller 16-bit two operand version of an instruction, and also built to decode a more complex 32-bit conditional three operand instruction using the same circuits.

In some other embodiment, a double prefix instruction with a condition and a hint may be combined with a consuming instruction to provide a hint about the general direction and/or probability of resolution of the condition on execution of the combined conditional instruction.

FIG. 14C illustrates an instruction combination that results in a combined instruction formed by combining a multi-operand prefix instruction with a consuming instruction, in accordance with one possible embodiment. Optionally, such an instruction combination may be performed by a multi-operand prefixing instruction combinator and decoder that may be implemented in the context of any of the foregoing figures.

In the embodiment of FIG. 14C, a multi-operand prefix instruction 1416 comprising a prefix opcode PFX3, a condition prefix COND, a type prefix TYPE (and/or a hint prefix HINT), and/or one or more location prefixes such as OPD_Z may be combined with a consuming instruction 1410 comprising an opcode B and operands such as OPD1 and OPD2 among others using a multi-operand prefixing instruction combinator and decoder. The process of combining the multi-operand prefix instruction and the consuming instruction is similar in manner to the processes disclosed and described heretofore, such as for e.g. in the context of FIG. 14B. The combined instruction 1436 obtained by combining the multi-operand prefix instruction 1416 and the consuming instruction 1410 comprises the instruction opcode B1, the condition COND, the type TYPE (or the hint HINT, if that was used), the location operand OPZ_Z, the operands OPD1, OPD2, and some or all of the other operands of instruction 1410. Instructions, instruction combinators and instruction decoders can be created using any of the techniques disclosed in here to allow for multiple kinds of operands like conditions, types, hints, location operands, etc. to be added to consuming instructions to modify their functionality at low cost. The type operands (e.g. TYPE) allow the instruction operand type to be modified from a default type. For e.g. an integer add instruction can converted into a floating point add instruction. Therefore, a conditional integer add instruction can be converted into a conditional floating point add instruction using the instruction combinator, and the decoder decodes the combined instruction accordingly. A hint prefix can be used to set the default direction of the conditional branch for determining branch target and subsequent instructions in speculative execution which may be corrected, if necessary, at a later stage.

In another embodiment, a function prefix with operand FUNC can be used along with any of the other prefix operands to modify or conditionally modify the functionality of the consuming instruction in the combined instruction. For example, an add instruction can be modified on overflow into an add-saturate instruction that saturates the addition result to the maximum value (or a minimum value in case of a negative value overflow).

FIG. 15A illustrates an aspect of multi-operand prefixing instruction combinator and decoder, in accordance with one embodiment. Optionally, the multi-operand prefixing instruction combinator and decoder may be implemented in the context of any of the foregoing figures.

In the embodiment of FIG. 15A, in a computing machine with one or more processors in communication with a non-transitory memory, where at least one of the one or more processors comprising a multi-operand prefixing instruction combinator and decoder 1500A that comprises a buffer that receives instructions of the computing machine from a memory. The instructions of the computing machine comprise a first instruction 1502 and a second instruction 1510, and wherein the first instruction may be a multi-operand prefix instruction comprising a first set of two or more operands (e.g. a condition operand COND, a type operand TYPE and a location operand OPD_Z) called the prefix operands, and a second instruction comprising one or more operands (e.g. OPD1, OPD2, etc.) wherein the second instruction may be capable of consuming one or more prefix operands from an operand prefix instruction/multi-operand prefix instruction. In some consuming instructions (e.g. consuming instruction 1510) at least one of the operands (e.g. OPD1) may be a location operand that names or points to a destination. Further, in some aspects the operand such as OPD1 may also name or point to a source. In one aspect, instruction 1502 comprises an opcode PFX3 which identifies instruction 1502 as a multi-operand prefix instruction 1502; and furthermore, consuming instruction 1510 comprises an opcode B. At least one of the one or more processors executes instructions of the computing machine.

During execution, the first instruction 1502 and the second instruction 1510 are fed to a set of one or more pre-decoder(s) that includes at least one pre-decoder 1522 which identifies a multi-operand prefix instruction (e.g. instruction 1502) and a consuming instruction (e.g. instruction 1510), one or more operand analyzer(s) (e.g. at least one operand analyzer 1524 comprising an operand analyzer logic circuit, when implemented in hardware; or an operand analyzer logic block/subroutine when implemented in software, or in microcode), and one or more multi-operand combining logic block(s) such as at least one multi-operand combining logic circuit 1526. These logic block(s) may be implemented as logic circuits in hardware, or as procedures, functions, or subroutine(s) in microcode in/on hardware, or using procedures, functions or subroutines in software when used in a binary translator or a simulator program. The pre-decoder(s) (e.g. pre-decoder 1522) may be implemented in hardware as circuits, or as subroutine(s) in microcode, or may be implemented in software as using functions, subroutines or procedures when used in a binary translation or simulator program.

The pre-decoder 1522 and operand analyzer 1524 determine whether to simply combine/embed the prefix operands with the consuming instruction, or if some prefix operands must be used to replace any operands of the consuming instruction, and to generate appropriate control signals (such as control signal 1536) accordingly.

The multi-operand combiner such as the operand combining logic circuit 1526 controlled by control signals from the pre-decoder(s) and operand analyzer(s) combines the prefix operands with the consuming instruction to generate a combined instruction (e.g. combined instruction 1530). In this process/step of instruction combination, the operand combining logic circuit/operand combining logic block also modifies the opcode of the consuming instruction (e.g. opcode B) to give the combined instruction 1530 a new opcode (e.g. opcode B1). The combined instruction 1530 is decoded by one or more instruction decoder(s) 1540.

FIG. 15B illustrates one aspect of a multi-operand prefixing instruction combinator and decoder, in accordance with one embodiment. Optionally, the multi-operand prefixing instruction combinator and decoder may be implemented in the context of any of the figures herein.

In one aspect shown in FIG. 15B, prefix instruction 1502 and consuming instruction 1510 are presented to an embodiment 1500B of multi-operand prefixing instruction combinator and decoder that comprises a first pre-decoder and operand analyzer 1528A that pre-decodes and analyzes a first instruction (which in the illustration in FIG. 15B is the prefix instruction 1502), and a second pre-decoder and operand analyzer 1528B that pre-decodes and analyzes a second instruction (which in the illustration in FIG. 15B is the consuming instruction 1510). Upon determining that instruction 1502 is a prefix instruction (a multi-operand prefix instruction, more specifically, with a first operand OPD_Z) comprising a new destination operand (e.g. first operand OPD_Z) and that instruction 1510 is a consuming instruction (with a second operand (e.g. OPD1) that is a source and destination operand, the pre-decoder and operand analyzers 1528A and 1528B present the first operand OPD_Z at a first input to a multiplexer 1534 and the second operand OPD1 to the second input of the multiplexer 1534, and the first pre-decoder and operand analyzer 1528A asserts a control signal 1536 to the multiplexer 1534 directing it to transmit the first operand OPD_Z. In response to the assertion of control signal 1536, the multiplexer 1534 transmits the first operand OPD_Z to its output which marks it as the new destination operand for the combined instruction. 1530. The operands in the other fields of the prefix instruction such as a condition operand (e.g. COND), and a type operand (e.g. TYPE) in this illustration are also transmitted/forwarded to be marked as fields of the combined instruction. In other cases, with other kinds of prefix operands, such prefix operands may be similarly transmitted to become part of the combined instruction. Furthermore, other operands (e.g. OPD2) of the consuming instruction besides the second operand OPD1 are also transmitted/forwarded to become part of the combined instruction. The opcode (e.g. opcode B) of the consuming instruction 1510 is modified or appended or tagged by the pre-decoder and operand analyzer and a new opcode (e.g. opcode B1) is generated which becomes the opcode for the combined instruction. The combined instruction 1530 may either be sent directly to decoder without first storing it, or the combined instruction 1530 may first be stored and then decoded. In some aspects, in response to the prefix opcode PFX3 a function modifier (e.g. FUNC1) may also be included in the combined instruction to designate the various new fields added to the combined instruction 1530 over the consuming instruction 1510. In one aspect, the fields of the combined instruction may comprise an opcode (e.g. B1), an optional condition (e.g. COND), an optional type (e.g. TYPE), a destination (e.g. DEST), zero or more source fields (e.g. SRC1, SRC2), and optionally, one or more function fields (e.g. FUNC1, FUNC2). Function field FUNC2, for example, may be a hint (e.g. HINT). In some aspects function FUNC1 or function FUNC2 may indicate that the destination operand is being replaced. In another aspect, functions FUNC1 or function FUNC2 may be a ‘don't-care’; or in some aspects they may not even exist. Furthermore, in some aspects, instead of a new destination operand, the first operand in the operand prefix instruction may be a new source operand. In some aspects, the size or width of the new destination operand may be different from that of the original destination operand, which allows a type casting to be performed as well.

FIG. 15C illustrates yet another aspect of a multi-operand prefixing instruction combinator and decoder 1500C, in accordance with one embodiment. Optionally, this aspect of the multi-operand prefixing instruction combinator and decoder may be implemented in the context of any of the figures herein.

In the aspect illustrated in FIG. 15C, prefix instruction 1502C and consuming instruction 1510 are presented to embodiment 1500C of multi-operand prefixing instruction combinator and decoder that comprises a first pre-decoder and operand analyzer 1528A that pre-decodes and analyzes a first instruction (which in the illustration in FIG. 15C is the prefix instruction 1502), and a second pre-decoder and operand analyzer 1528B that pre-decodes and analyzes a second instruction (which in the illustration in FIG. 15B is the consuming instruction 1510 with a second operand OPD1). Upon determining that instruction 1502 is a prefix instruction comprising prefix operands such as a condition operand COND, a type operand TYPE, and a hint operand HINT, the first pre-decoder and operand analyzer 1528A de-asserts (NOT assert) a control signal 1536 to the multiplexer 1534 directing it to transmit the second operand OPD1 presented at its second input. In response to the assertion of control signal 1536, the multiplexer 1534 transmits the second operand OPD1 to its output which is the destination operand for the combined instruction 1530C.

The operands in the other fields of the prefix instruction 1502C such as a condition operand (e.g. COND), and a type operand (e.g. TYPE), and a hint operand (e.g. HINT) in this illustration are also transmitted/forwarded to be marked as fields of the combined instruction. In other cases, with other kinds of prefix operands, such prefix operands may be similarly transmitted to become part of the combined instruction. Furthermore, other operands (e.g. OPD2) of the consuming instruction besides the second operand OPD1 are also transmitted/forwarded to become part of the combined instruction. The opcode (e.g. opcode B) of the consuming instruction 1510 is modified or appended or tagged by the pre-decoder and operand analyzer and a new opcode (e.g. opcode B2) is generated which becomes the opcode for the combined instruction. In some aspects, in response to the prefix opcode PFX3 a function modifier (e.g. FUNC1) may also be included in the combined instruction to designate the various new fields added to the combined instruction 1530C over the consuming instruction 1510. In one aspect, the fields of the combined instruction may comprise an opcode (e.g. B2), an optional condition (e.g. COND), an optional type (e.g. TYPE), a destination (e.g. DEST), zero or more source fields (e.g. SRC1, SRC2), and optionally, one or more function fields (e.g. FUNC1, FUNC2). Function field FUNC2, for example, may be a hint (e.g. HINT). The combined instruction 1530C may either be sent directly to decoder without first storing it, or the combined instruction 1530C may first be stored and then decoded.

As used in herein, the term conjunction refers to the act of combining, or appending, pre-fixing, suffixing, swapping, substituting, replacing a field in the context of operands, or opcodes, or functions, or in general, fields of an instruction in the process of creating a combined instruction or resultant instruction.

While specific embodiments of the invention have been described, it is understood that the present invention is not intended to be limited only to such embodiments. Additionally, the scope of the preferred embodiment should be defined by the following claims and their equivalents. Moreover, any combination of the above-described elements in all possible variations thereof is encompassed unless otherwise indicated herein or otherwise clearly contradicted by context. Further, the use of the terms “a” and “an” and “the” and similar referents in the context of describing the subject matter (particularly in the context of the claims) are to be construed to cover both the singular and the plural, unless otherwise indicated herein or clearly contradicted by context. No language in the specification should be construed as indicating any non-claimed element as essential to the practice of the invention as claimed.

1. A computing machine, comprising:
at least one processor in communication with a non-transitory memory, wherein the at least one processor executes instructions of the computing machine, the instructions of the computing machine comprising a first instruction and a second instruction, wherein the first instruction is an operand prefix instruction comprising at least one prefix operand;
an operand prefix identifying mechanism that identifies the operand prefix instruction and determines the at least one prefix operand; and
an operand selection mechanism that selects the at least one prefix operand and combines the at least one prefix operand with at least some portion of the second instruction to create a combined instruction.

2. The computing machine of claim 1, wherein the operand prefix identifying mechanism is a prefix instruction identifying pre-decoder.

3. (canceled)

4. The computing machine of claim 1, wherein the operand prefix identifying mechanism is implemented in hardware.

5. (canceled)

6. The computing machine of claim 1, wherein the at least one prefix operand serves as a destination operand of the combined instruction.

7. The computing machine of claim 1, wherein the at least one prefix operand serves as a source operand of the combined instruction.

8. The computing machine of claim 1, where in the at least one prefix operand is a register operand.

9-18. (canceled)

19. A computing machine comprising a pre-decoder that identifies an operand prefix instruction;
an operand analyzer that performs analysis and rejects or accepts at least one prefix operand to combine with a consuming instruction;
and an operand combiner that combines the at least one prefix operand with the consuming instruction to create a combined instruction for execution.

20. The computing machine of claim 19, wherein the operand prefix instruction is a register operand prefix instruction.

21. The computing machine of claim 19, wherein the operand prefix instruction is an extended register operand prefix instruction.

22. The computing machine of claim 19, wherein the operand prefix instruction comprises a new destination operand.

23. The computing machine of claim 19, wherein the operand prefix instruction is a condition operand prefix instruction.

24. The computing machine of claim 19, wherein the operand prefix instruction is a hint operand prefix instruction.

25. The computing machine of claim 19, wherein the operand prefix instruction is a type operand prefix instruction.

26. The computing machine of claim 19, wherein the operand prefix instruction is a function operand prefix instruction.

27. A computing machine comprising an operand prefixing instruction combinator and decoder further comprising:
a first pre-decoder, wherein the first pre-decoder identifies an operand prefix instruction;
a second pre-decoder, wherein the second pre-decoder identifies a consuming instruction;
at least one operand analyzer that performs analysis and rejects or accepts at least one prefix operand to combine with the consuming instruction; and
at least one operand combiner that combines the at least one prefix operand with the consuming instruction to create a combined instruction.

28. The computing machine of claim 27, wherein the operand prefixing instruction combinator and decoder are multi-operand prefixing instruction combinator and decoder.

29. The computing machine of claim 27, wherein an operand prefix instruction comprises a condition operand and a destination operand.

30. The computing machine of claim 27, wherein the operand prefixing instruction combinator and decoder are implemented as a logic circuit.

31. The computing machine of claim 27, wherein the operand prefixing instruction combinator and decoder are implemented in microcode at least in part.

32. The computing machine of claim 27, wherein the computing machine comprises at least one processor that is in communication with a non-transitory memory, wherein the at least one processor executes instructions of the computing machine, wherein the operand prefixing instruction combinator is implemented in a software program product at least in part.
